(19) United States
(12) Patent Application Publication
(10) Pub. No.: US 2012/0170855 A1
(43) Pub. Date: Jul. 5, 2012

(54) IMAGE MANAGEMENT DEVICE, IMAGE MANAGEMENT METHOD, PROGRAM, RECORDING MEDIUM, AND IMAGE MANAGEMENT INTEGRATED CIRCUIT

(75) Inventor: Kazuhiko Maeda, Osaka (JP)

(73) Assignee: Panasonic Corporation, Osaka (JP)

(21) Appl. No.: 13/496,323

(22) PCT Filed: Apr. 14, 2011
(86) PCT No.: PCT/JP2011/002204

§ 371 Date: Mar. 15, 2012

(30) Foreign Application Priority Data
Jul. 21, 2010 (JP) 2010-163811

(51) Int. Cl. G06K 9/68

(52) U.S. Cl. 382/218

(57) ABSTRACT

An image management device includes an image priority calculation unit calculating image priority, an image selection unit selecting a high-priority image and a low-priority image, a feature correction unit correcting low-priority image features using the object features of objects included in the high-priority image and in the low-priority image, an image similarity calculation unit calculating image similarity using the object features of the high-priority image and the object features corrected by the feature correction unit, and an image priority correction unit correcting the priority of the low-priority image according to the calculated image similarity.

### TECHNICAL FIELD

The present invention relates to image management technology for seeking out a desired image among a multitude of images.

### BACKGROUND ART

Conventional technology allows great quantities of images captured and stored by a digital camera to be ranked and displayed in descending order of priority, as determined for a user (see Patent Literature 1 and 2).

According to the technology of Patent Literature 1 and 2, photographic subject images (objects), such as human faces, included in the stored images are first extracted, and object features are then calculated for each. The objects are then sorted according to the object features, and an object priority is calculated for each object according to the results. Then, an image priority is calculated for each image where objects are found, according to the object priority calculated therefor. The images are ranked in terms of priority.

This type of ranking method may, for example, define object priority for a given object as the number of times objects sorted identically (into a common cluster) to the given object appear in a plurality of stored images. The image priority of each image is then the total object priority of all objects appearing therein (see Patent Literature 3).

When such a ranking method is used, the more often an object appears, the higher the object priority, and the more high-priority objects are included in an image, the higher the rank thereof in terms of image priority.

### CITATION LIST

### Patent Literature

[Patent Literature 1]
Japanese Patent Application Publication No. 2004-46591
[Patent Literature 2]
Japanese Patent Application Publication No. 2005-20446
[Patent Literature 3]
Japanese Patent Application Publication No. 2007-60562

### SUMMARY OF INVENTION

### Technical Problem

However, according to the technology described in Patent Literature 1 and 2, an object corresponding to a given photographic subject may be treated as corresponding to a different photographic subject, due to differences in capture conditions and the like. For example, poor capture conditions may cause a photographic subject to appear partly shadowed. In such circumstances, the shadowed photographic subject may be treated as a different photographic subject rather than the photographic subject actually captured. Alternatively, an object may be treated as corresponding to a different photographic subject depending on whether the subject is front lit or back lit, or according to differences in lighting level. That is, a photographic subject captured in the presence of environmental noise may result in an object treated as corresponding to a different photographic subject.

As a result, when the above-described ranking method is used, images may be misranked as the priority of the objects is not correctly calculated.

In view of the above, the present invention aims to provide an image management device able to correctly calculate image priority.

### Solution to Problem

In order to solve the above-described problem, an image management device comprises: an image priority calculation unit calculating an image priority for each of a plurality of images according to object features of each of a plurality of objects included in the images; an image selection unit selecting, according to the image priority calculated for the images, a first image and a second image such that the image priority of the second image is lower than the image priority of the first image; a feature correction unit correcting the object features of the objects included in the second image using a correction function that takes the object features of the objects included in the first image and the object features of the objects included in the second image as parameters; an image similarity calculation unit calculating an image similarity representing a degree of similarity between the first image and the second image, the image similarity being calculated using the object features of the objects included in the first image and the object features of the objects included in the second image as corrected by the feature correction unit; and an image priority correction unit correcting the image priority of the second image according to the image priority of the first image and the image similarity calculated by the image similarity calculation unit.

### Advantageous Effects of Invention

According to this structure, the object features of the objects included in the second image are corrected according to a correction function taking the object features of objects included in the first image and of objects included in the second image as parameters. The correction is applied, as appropriate, according to the similarity between the two images, so as to eliminate any noise included in the objects. Accordingly, the object features of the objects included in the second image are correctly calculated, allowing the image priority of the second image to be correctly calculated in turn.

Also, in the image management device, the image priority of the first image is higher than a predetermined priority, and the image priority of the second image is lower than the predetermined priority.

Accordingly, the quantity of images subject to priority re-evaluation is appropriately set through a predetermined priority. As such, the processing load on the image management device is reduced.

Further, in the image management device, an object quantity comparative determination unit comparing quantities of objects included in the first image and in the second image, wherein the feature correction unit corrects the object features of the objects included in the second image when the object quantity comparative determination unit determines that the quantities of objects included in the first image and in the second image are equal.

Accordingly, the first image and the second image are selected only from images exhibiting noise-related differences in object features. As such, the processing load on the image management device is reduced.

In addition, in the image management device, the correction function, when applied, corrects the object features of the objects included in the second image using a correction coefficient calculated from a first average value obtained for the object features of the objects included in the first image and from a second average value obtained for the object features of the objects included in the second image.

Accordingly, the correction function is calculated according to correction coefficients taken from the average of the object features of objects respectively included in the first and second images. Thus, any correspondence relationships between objects included in the first and second images does not affect the correction coefficients. As such, the processing required to identify correspondence relationships between objects included in the first and second images may be omitted, thereby reducing the processing load on the image management device.

Furthermore, in the image management device, the correction coefficient is the ratio of the first average value to the second average value, and the correction function multiplies the object features of the objects included in the second image by the correction coefficient.

Accordingly, noise-related differences between features are extracted from the respective object features of objects included in the first and second images. As such, noise is reliably eliminated.

Further still, in the image management device, the correction coefficient is the difference between the first average value and the second average value, and the correction function adds the correction coefficient to the object features of the objects included in the second image.

Accordingly, the occurrence of zeroes in the respective object features of objects included in the second image does not require the feature correction unit to perform a divide-by-zero error prevention process. This simplifies the processing performed by the feature correction unit.

Additionally, in the image management device, the image similarity calculation unit further includes: an image object similarity calculation unit calculating a respective similarity between each of the objects included in the first image and each of the objects included in the second image and establishing one-to-one correspondence between the objects included in the first image and the objects included in the second image according to the respective similarity so calculated; and an average similarity calculation unit calculating an average similarity value from the similarities between objects for which the image object similarity calculation unit establishes one-to-one correspondence and outputting the result as the image similarity.

Accordingly, the effect of noise-related discrepancies in object features on the object similarity is suppressed. As such, the object features are corrected with greater accuracy.

Moreover, in the image management device, the image object similarity calculation unit establishes correspondence between a pair of objects corresponding to a highest similarity value as calculated, excludes the two objects, and then establishes correspondence between another pair of objects corresponding to a next highest similarity value.

Accordingly, correspondence between objects is established according to the objects similarity, only. Thus, the object correspondence process is simplified for the object correspondence calculation unit.

Furthermore, in the image management device, the image priority correction unit further corrects the image priority of the second image according to the average size of the objects included in the first image and the average size of the objects included in the second image.

Accordingly, the difference in size between objects included in the first and second images is reflected in the priority of the second image. As such, the priority of the second image is calculated with greater precision.

Also, in the image management device, the image priority correction unit corrects the image priority of the second image using a relational expression as given below:

Scn′=(Scm−Scn)×Sg×(Ssavem/Ssaven)+Scn [Math. 1]

where Sg is the image similarity, Scm is the image priority of the first image, Scn is the image priority of the second image, Ssaven is the average size of the objects included in the second image, and Ssavem is the average size of the objects included in the first image.

Further, an image priority calculation unit calculating an image priority for a plurality of images according to object features of objects included in the images; an image selection unit selecting, according to the image priority calculated for the images, a first image and a second image such that the image priority of the second image is lower than the image priority of the first image; a feature correction unit correcting the object features of the objects included in the second image using a correction function that multiplies each of the object features of the objects included in the second image by the ratio of the object features of a selected object among the objects included in the first image to the object features of the objects included in the second image, and outputting the results; an image similarity calculation unit calculating an image similarity representing a degree of similarity between the first image and the second image, the image similarity being calculated using the object features of the objects included in the first image and the object features of the objects included in the second image as output from the feature correction unit; and an image priority correction unit correcting the image priority of the second image according the image similarity calculated by the image similarity calculation unit.

Accordingly, the object features of objects included in the second image are corrected, as appropriate, according to the respective object features of the objects included in the first and second image. As such, any noise included in the object features of the objects included in the second image is eliminated, allowing the priority of the second image to be correctly calculated.

Alternatively, the present invention provides an image management method comprises an image priority calculation step of calculating an image priority for each of a plurality of images according to object features of each of a plurality of objects included in the images; an image selection step of selecting, according to the image priority calculated for the images, a first image and a second image such that the image priority of the second image is lower than the image priority of the first image; a feature correction step of correcting the object features of the objects included in the second image using a correction function that takes the object features of the objects included in the first image and the object features of the objects included in the second image as parameters; an image similarity calculation step of calculating an image similarity representing a degree of similarity between the first image and the second image, the image similarity being calculated using the object features of the objects included in the first image and the object features of the objects included in the second image as corrected in the feature correction step; and an image priority correction step of correcting the image priority of the second image according to the image priority of the first image and the image similarity calculated in the image similarity calculation step.

Accordingly, the object features of objects included in the second image are corrected, as appropriate, according to the respective object features of the objects included in the first and second image. As such, any noise included in the object features of the objects included in the second image is eliminated, allowing the priority of the second image to be correctly calculated.

In addition, the present invention provides an image management program for execution by a computer managing a plurality of images, the image management program comprising: an image priority calculation step of calculating an image priority for each of a plurality of images according to object features of each of a plurality of objects included in the images; an image selection step of selecting, according to the image priority calculated for the images, a first image and a second image such that the image priority of the second image is lower than the image priority of the first image; a feature correction step of correcting the object features of the objects included in the second image using a correction function that takes the object features of the objects included in the first image and the object features of the objects included in the second image as parameters; an image similarity calculation step of calculating an image similarity representing a degree of similarity between the first image and the second image, the image similarity being calculated using the object features of the objects included in the first image and the object features of the objects included in the second image as corrected in the feature correction step; and an image priority correction step of correcting the image priority of the second image according to the image priority of the first image and the image similarity calculated in the image similarity calculation step.

Accordingly, the object features of objects included in the second image are corrected, as appropriate, according to the respective object features of the objects included in the first and second image. As such, any noise included in the object features of the objects included in the second image is eliminated, allowing the priority of the second image to be correctly calculated.

Further, the present invention provides a recording medium on which is recorded an image management program for execution by a computer managing a plurality of images, the image management program comprising: an image priority calculation step of calculating an image priority for each of a plurality of images according to object features of each of a plurality of objects included in the images; an image selection step of selecting, according to the image priority calculated for the images, a first image and a second image such that the image priority of the second image is lower than the image priority of the first image; a feature correction step of correcting the object features of the objects included in the second image using a correction function that takes the object features of the objects included in the first image and the object features of the objects included in the second image as parameters; an image similarity calculation step of calculating an image similarity representing a degree of similarity between the first image and the second image, the image similarity being calculated using the object features of the objects included in the first image and the object features of the objects included in the second image as corrected in the feature correction step; and an image priority correction step of correcting the image priority of the second image according to the image priority of the first image and the image similarity calculated in the image similarity calculation step.

Accordingly, the object features of objects included in the second image are corrected, as appropriate, according to the respective object features of the objects included in the first and second image. As such, any noise included in the object features of the objects included in the second image is eliminated, allowing the priority of the second image to be correctly calculated.

Also, the present invention provides an integrated circuit comprising: an image priority calculation unit calculating an image priority for each of a plurality of images according to object features of each of a plurality of objects included in the images; an image selection unit selecting, according to the image priority calculated for the images, a first image and a second image such that the image priority of the second image is lower than the image priority of the first image; a feature correction unit correcting the object features of the objects included in the second image using a correction function that takes the object features of the objects included in the first image and the object features of the objects included in the second image as parameters; an image similarity calculation unit calculating an image similarity representing a degree of similarity between the first image and the second image, the image similarity being calculated using the object features of the objects included in the first image and the object features of the objects included in the second image as corrected by the feature correction unit; and an image priority correction unit correcting the image priority of the second image according to the image priority of the first image and the image similarity calculated by the image similarity calculation unit.

Accordingly, the image management device is miniaturizable.

### BRIEF DESCRIPTION OF DRAWINGS

FIG. 1 is an overall configuration diagram of an image management device pertaining to Embodiment 1.

FIG. 2 illustrates a plurality of images as explained in Embodiment 1.

FIG. 3 indicates objects included in each of the plurality of images as explained in Embodiment 1.

FIG. 4 indicates image IDs for each of the images and object IDs of the objects included therein as explained in Embodiment 1.

FIG. 5 indicates the features of each object as explained in Embodiment 1.

FIG. 6 indicates clusters to which the objects belong and the object priority of the objects sorted into the clusters as explained in Embodiment 1.

FIG. 7 indicates cluster IDs for each cluster to which the objects belong and the object priority of each of the objects as explained in Embodiment 1.

FIG. 8 indicates image priority for each of the images as explained in Embodiment 1.

FIG. 9 is a schematic diagram of the image priority data stored in an image priority memory as explained in Embodiment 1.

FIG. 10 indicates a ranking for each of the images as explained in Embodiment 1.

FIG. 11 indicates quantities of objects included in each of the plurality of images as explained in Embodiment 1.

FIG. 12 indicates objects included in images I012 and I013 as explained in Embodiment 1.

FIG. 13 is a diagram used to illustrate the operations of a feature correction unit as explained in Embodiment 1.

FIG. 14 indicates the object features of the objects included in image I012 and average feature value vector G012 for the objects as explained in Embodiment 1.

FIG. 15 indicates the object features of the objects included in image I013 and average feature value vector G013 for the objects as explained in Embodiment 1.

FIG. 16 indicates correction vector Ch, obtained through division using the components of average feature value vector G012 for the objects included in image I012 and average feature value vector G013 for the objects included in image I013, as explained in Embodiment 1.

FIG. 17 indicates the object feature vector of each object included in image I013, post-correction, as explained in Embodiment 1.

FIG. 18 indicates the similarity between each of the objects included in image I012 and each of the objects included in image I013 as explained in Embodiment 1.

FIG. 19 illustrates a description of the similarity calculation process for the similarity between each of the objects included in image I012 and each of the objects included in image I013 as explained in Embodiment 1.

FIG. 20 indicates the corrected image priority as explained in Embodiment 1.

FIG. 21 indicates re-ranking results as explained in Embodiment 1.

FIG. 22 is a flowchart of the operations of the image management device pertaining to Embodiment 1.

FIG. 23 is a flowchart of the object similarity calculation operations of the image management device pertaining to Embodiment 1.

FIG. 24A is a flowchart of the high-priority image Im acquisition operations of the image management device pertaining to Embodiment 1. FIG. 24B is a flowchart of the image priority correction process of the image management device pertaining to Embodiment 1.

FIG. 25 is an overall configuration diagram of an image management device pertaining to Embodiment 2.

FIG. 26 indicates images I012 and I013 as explained in Embodiment 2.

FIG. 27 indicates correction vectors Ch1, Ch2, and Ch3 as explained in Embodiment 2.

FIG. 28 indicates the object feature vector of each object included in image I013, post-correction, as explained in Embodiment 2.

FIG. 29 illustrates a description of the similarity calculation process for the similarity between each of the objects included in image I012 and each of the objects included in image I013 as explained in Embodiment 2.

FIG. 30 is a flowchart of the operations of the image management device pertaining to Embodiment 2.

FIG. 31 is a flowchart of the object similarity calculation operations of the image management device pertaining to Embodiment 2.

FIG. 32 is a flowchart of the image priority correction process of the image management device pertaining to Embodiment 2.

FIG. 33 indicates correction vectors Chs as explained in Embodiment 3.

FIG. 34 indicates the object feature vector of each object included in image I013, post-correction, as explained in Embodiment 3.

FIG. 35 is a flowchart of the similarity calculation operations for each object, pertaining to Embodiment 3.

FIG. 36 indicates images I012 and I013 as explained in Embodiment 4.

### DESCRIPTION OF EMBODIMENTS

### Embodiment 1

1. Configuration

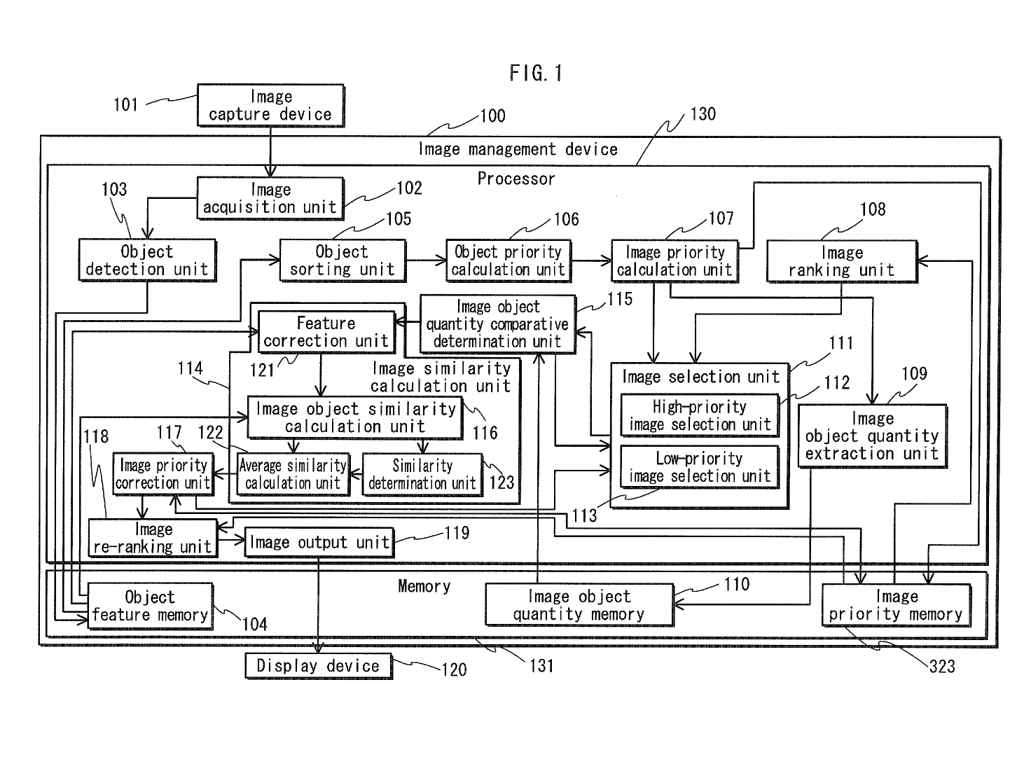

FIG. 1 shows the configuration of an image management device 100 pertaining to the present Embodiment.

The image management device 100 includes memory 131 and a processor 130. The image management device 100 also includes a non-diagrammed Universal Serial Bus (USB) input terminal and a High-Definition Multimedia Interface (HDMI) output terminal.

The USB input terminal is an input interface connecting to a (non-diagrammed) connector provided at one end of a USB cable. The other end of the USB cable is connected to an image capture device 101. Later-described image data are transmitted from the image capture device 101 to the USB input terminal through the USB cable.

The HDMI output terminal is connected to a (non-diagrammed) connector provided at one end of an HDMI cable. The other end of the HDMI cable is connected to a display device 120. Later-described image ranking data are output from the HDMI output terminal to the display device 120.

The memory 131 is configured as Dynamic Random Access Memory (DRAM) or similar.

The processor 130 is configured as a general-use CPU.

The image capture device 101 captures an image and stores data (image data) thereof. Examples of the image capture device 101 includes a digital camera and so on. Further, the image capture device 101 transmits the image data through the USB cable to the image management device 100. The image data are collections of image pixel data. The images expressed by the image data are still images, such as photographs.

The display device 120 also displays a priority rank for each image. The priority rank is based on image ranking data transmitted from the image management device 100 through the HDMI cable. The display device 120 is, for example, a digital television displaying video output by a broadcast terminal.

Provided that the processor 130 executes the appropriate program stored in the memory 131, the image management device 100 also includes an image acquisition unit 102, an object detection unit 103, an object sorting unit 105, an object priority calculating unit 106, an image priority calculating unit 107, an image ranking unit 108, an image object quantity extraction unit 109, an image selection unit 111, an image similarity calculation unit 114, an image priority correction unit 117, an image re-ranking unit 118, and an image output unit 119.

The memory 131 further includes portions used as an object feature memory 104, an image object quantity memory 110, and an image priority memory 323.

1.1 Image Acquisition Unit

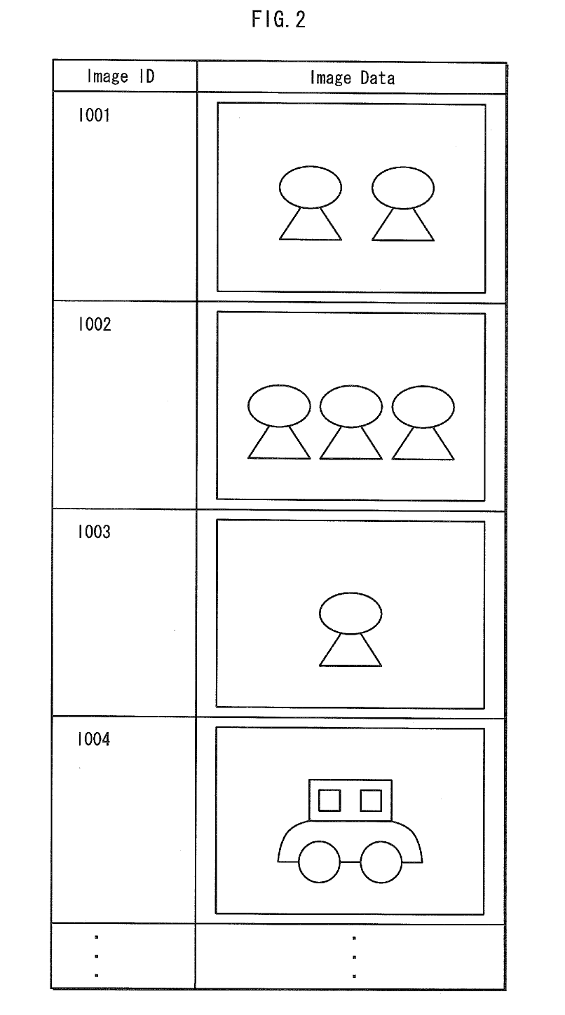

The image acquisition unit 102 assigns an image identifier (image ID) to each of a plurality of images corresponding to the image data input from the USB input terminal. FIG. 2 shows sample images given by image data and the image IDs assigned thereto. Each image ID is an identifier uniquely identifying the image within the image management device 100, and is generated by the image acquisition unit 102. The image acquisition unit 102 generates the image IDs from a number representing the order in which the images are acquired by the image acquisition unit 102 with the letter I affixed as a header. For example, in FIG. 2, the image acquisition unit 102 has acquired the image data in top-down order, as shown. In the following explanation, the image IDs are used to distinguish between images. For example, the image corresponding to the image data having image ID I001 assigned thereto is referred to as image I001.

1.2 Object Detection Unit

The object detection unit 103 detects objects by performing template matching on the image data acquired by the image acquisition unit 102, using a template corresponding to a predetermined object, stored in advance. The object detection unit 103 then assigns an object ID to each object thus detected, for identification purposes.

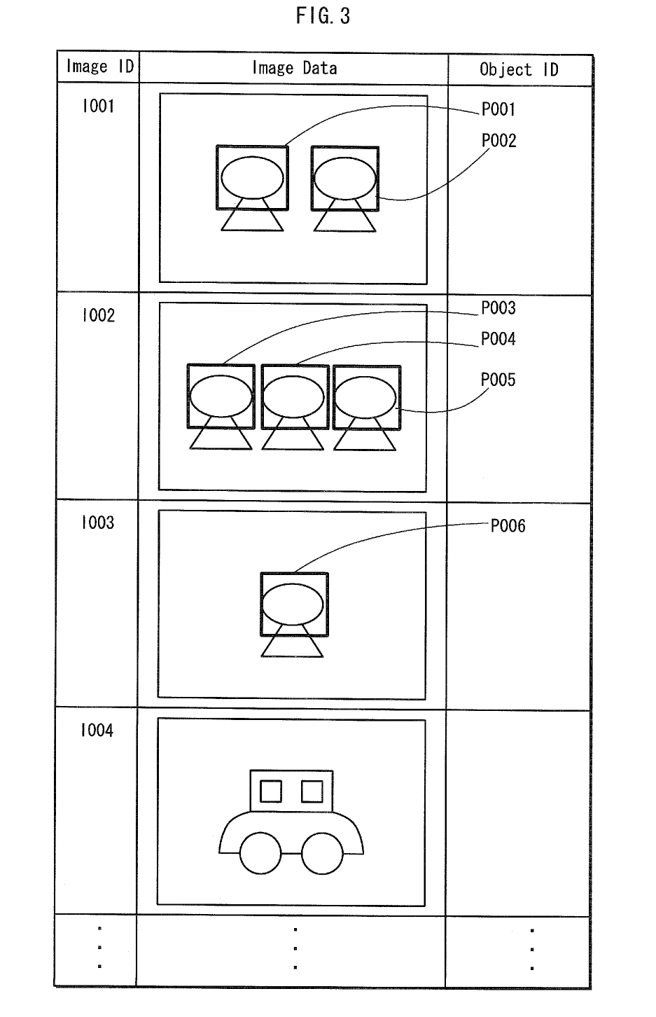

FIG. 3 shows examples of objects detected in the images. As shown, a given image may include a single object, multiple objects, or no objects at all. Each object ID is an identifier uniquely identifying the object within the image management device 100. The object IDs are in one-to-one correspondence with the objects.

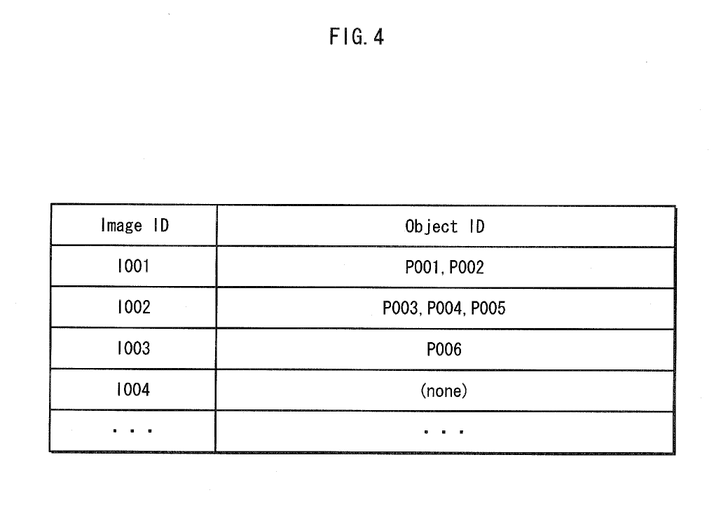

The object IDs are generated by the object detection unit 103. The object IDs are generated from a number assigned sequentially, beginning with 1, as the objects are detected by the object detection unit 103, and have the letter P affixed as a header. In the example of FIG. 3, the two objects included in image I001 have object IDs P001 and P002, the three objects included in image I002 have object IDs P003, P004, and P005, and the object included in image I003 has object ID P006. FIG. 4 lists the object IDs assigned to each object.

The object detection unit 103 also extracts object features from each detected object. The object features are calculated from, for example, the frequency or orientation of a plurality of pixel values making up an object obtained using a Gabor filter. As such, object features for an image of a human face may be the distance between two areas identified as eyes, or the distance between an area identified as a nose and an area identified as a mouth. These areas are calculated according to the orientation and periodicity of the pixel values.

1.3 Object Feature Memory

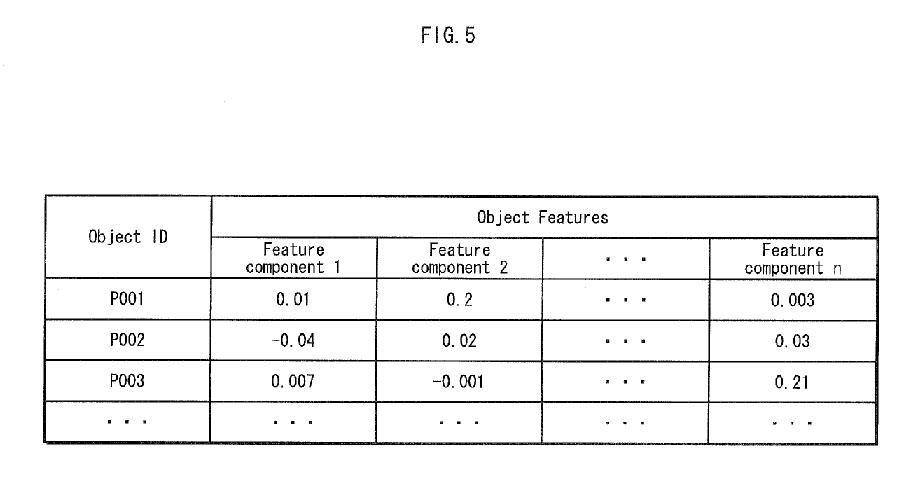

The object feature memory 104 is a portion of the memory 131 configured to store the object features of each object as extracted by the object detection unit 103. FIG. 5 lists an example thereof.

Also, as shown, each object has several types of object features (feature component 1, feature component 2 . . . feature component n). The following describes feature component 1, feature component 2 . . . feature component n as components of a feature vector. The feature vector is used by the object sorting unit 105 and by the image similarity calculation unit 114.

1.4 Object Sorting Unit

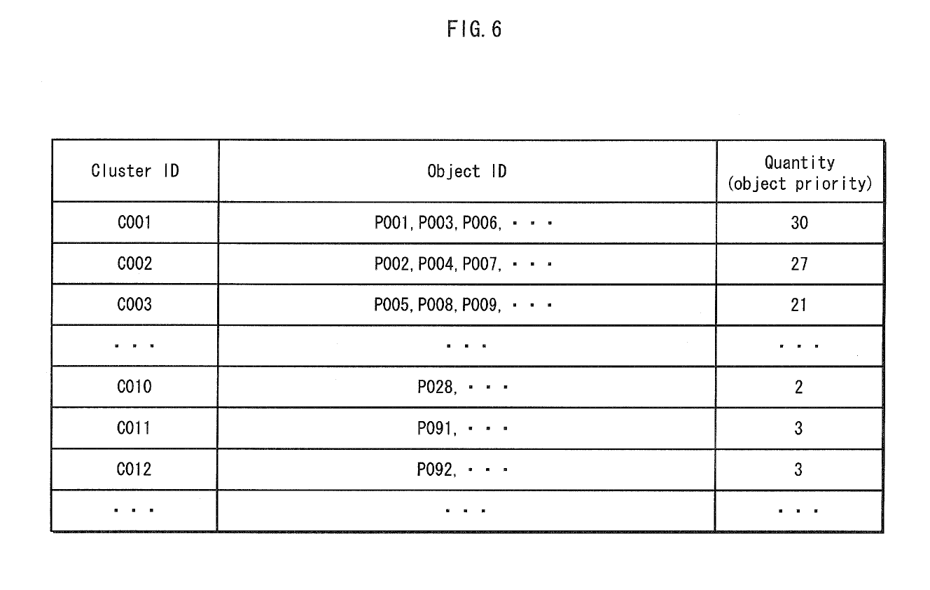

The object sorting unit 105 first uses the K-means method to automatically generate a plurality of clusters based on the feature vector of each object stored in the object feature memory 104, then sorts each of the objects into an appropriate cluster. The object sorting unit 105 also assigns an individual cluster ID to each cluster. Thus, a correspondence is established between the cluster IDs, the object IDs of the objects sorted therein, and the quantity of objects sorted therein. FIG. 6 lists an example in which a plurality of objects are sorted into a plurality of clusters.

1.5 Object Priority Calculation Unit

The object priority calculation unit 106 calculates an object priority for each object. The object priority for a given object is the quantity of objects sorted into a common cluster with the given object.

The quantity of objects sorted into a common cluster with the given object is used as the object priority on the grounds that objects sorted into a common cluster are likely to correspond to a single photographic subject, and that the more often a given photographic subject appears in a plurality of images, the more likely the subject is tube of interest to the user.

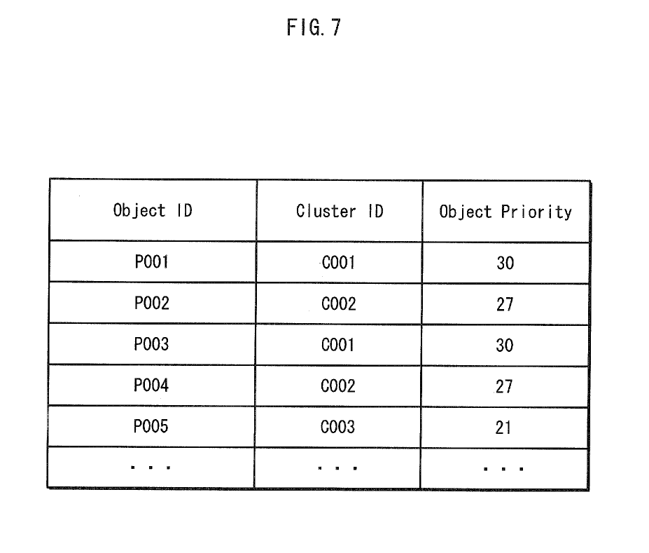

An example of object priority as calculated for the objects by the object priority calculation unit 106 is given in FIG. 7.

1.6 Image Priority Calculation Unit

The image priority calculation unit 107 calculates an image priority for each of the images by summing the object priorities of all objects included in each image. The image priority calculation unit 107 calculates the image priority of each image by reading out the object priority for each object, as stored in the object priority calculation unit 106.

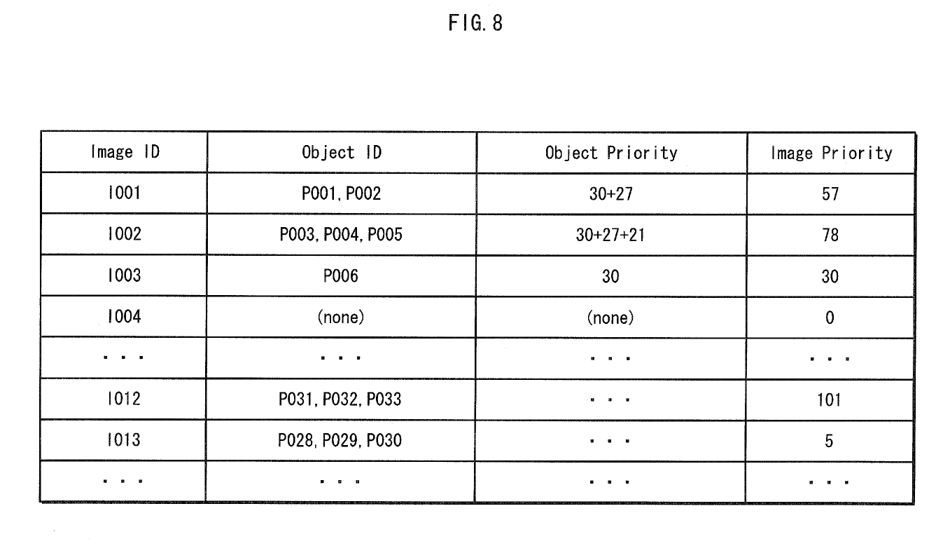

In the example of FIG. 8, objects P001 and P002 included in image I001 have the respective object priorities 30 and 27. Thus, the image priority of image 1001 is 57, found by summing 30, the object priority of object P001, and 27, the object priority of object P002.

The image priority calculation unit 107 also notifies the image object quantity extraction unit 109 and the image selection unit 111 of the object IDs for each object included in a given image, once the image priority of the given image is calculated.

1.7 Image Priority Memory

The image priority memory 323 is a portion of the memory 131 configured to store the image priority, as calculated by the image priority calculation unit 107, along with the image IDs and so on.

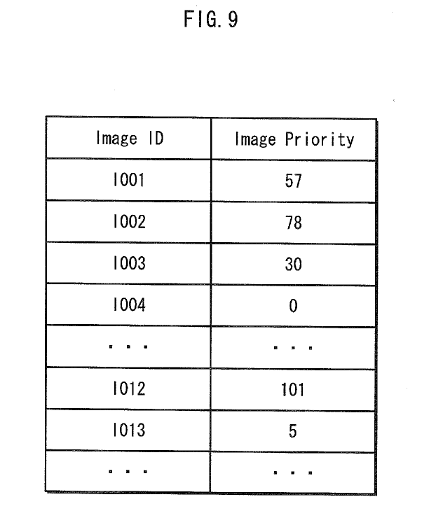

As shown in the example of FIG. 9, the image priority memory 323 stores the image ID of each image in correspondence with the image priority thereof.

1.8 Image Ranking Unit

The image ranking unit 108 performs a ranking of the images, based on the image priority of each image as read out from the image priority memory 323.

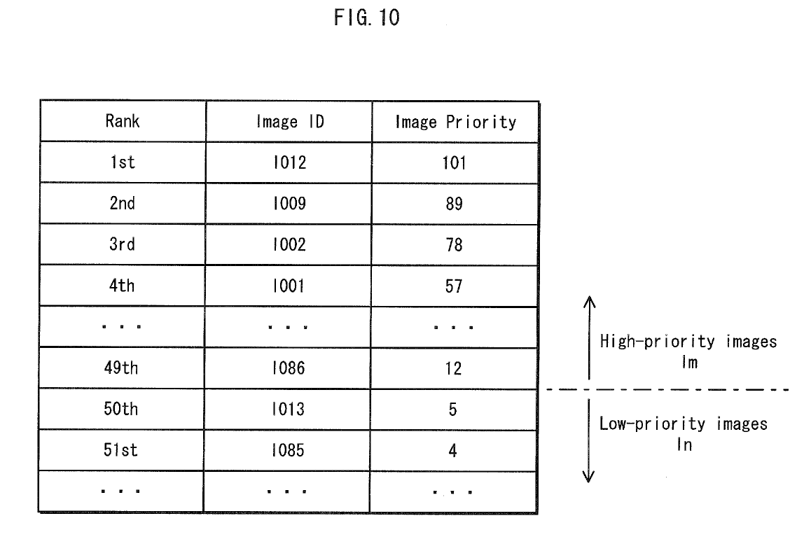

FIG. 10 shows an example of the ranking results obtained by ordering the images according to image priority. As shown, image I012, having an image priority of 101, is ranked first, followed by image I009, image I002, and so on. In the example given, the image ranking unit 108 arranges the images in descending order of image priority. When multiple images having the same image priority are present, the image ranking unit 108 ranks the images such that the image with the most recent image ID assigned thereto is ranked higher.

1.9 Image Object Quantity Extraction Unit

The image object quantity extraction unit 109 outputs an object quantity for image Im or image In. The object quantity is obtained by counting the object IDs received by notification from the image priority calculation unit 107.

1.10 Image Object Quantity Memory

The image object quantity memory 110 is a portion of the memory 131 configured to store the object quantities, as calculated by the image object quantity extraction unit 109, along with the image IDs. As shown in the example of FIG. 10, the quantity of objects included in each image (e.g., 3, 5, and 3 for images I012, I009, and I002, respectively) is stored in correspondence with the image ID I012, I009, I002, and so on.

1.11 Image Selection Unit

The image selection unit 111 selects images Im having priority above a predetermined priority threshold (high-priority images), and images In having priority below the predetermined priority threshold (low-priority images). These selections are made among the plurality of images ranked by the image ranking unit 108.

The predetermined priority threshold corresponds to the image priority of an image at a predetermined rank (e.g., rank M). The user is able to set the predetermined rank as preferred, by using a (non-diagrammed) priority settings unit provided in the image management device 100.

The image selection unit 111 includes a high-priority image selection unit 112 selecting high-priority images Im and a low-priority image selection unit 113 selecting low-priority images In.

As shown in FIG. 10, the high-priority image selection unit 112 selects the image having the highest image priority (the image ranked first) and all subsequent images, until reaching the image ranked Mth (49th in the example of FIG. 10) as the high-priority images Im among the plurality of ranked images. The high-priority image selection unit 112 also notifies an image object quantity comparative determination unit 115 of the image ID of each selected high-priority image Im upon selection thereof. The high-priority image selection unit 112 also affixes information identifying each high-priority image Im as having been selected to the image ID of each selected image.

Furthermore, when a selected high-priority image Im includes only one object, the high-priority image selection unit 112 selects a different high-priority image Im. This is done because a later-described feature correction unit 121 cannot appropriately correct object features for a high-priority image Im that includes only one object. That is, when the image includes only one object, the process merely serves to match the image priority of a low-priority image Im to the image priority of the high-priority image In.

As shown in FIG. 10, the low-priority image selection unit 113 selects the image ranked M+1th (50th in the example of FIG. 10, also the highest-priority image among images having an image priority below the predetermined priority threshold) and all subsequent images, until reaching the image ranked lowest, as low-priority images In among the plurality of ranked images. The low-priority image selection unit 113 also notifies the image object quantity comparative determination unit 115 of the image ID of each selected low-priority image Im upon selection thereof. The low-priority image selection unit 113 also affixes information identifying each low-priority image In as having been selected to the image ID of each selected image. In the present Embodiment, the low-priority image selection unit 113 selects the images ranked M+1th through lowest among the plurality of ranked image. However, this is not intended as a limitation. The low-priority image selection unit 113 may also select the images ranked M+x (where x=1, 2 . . . ) and so on, in order.

1.12 Image Object Quantity Comparative Determination Unit

The image object quantity comparative determination unit 115 obtains the total quantity of objects included in the high-priority images Im and the total quantity of objects included in the low-priority images In having specific image IDs from the image object quantity memory 110. The specific image IDs are the image IDs of which the high-priority image selection unit 112 and the low-priority image selection unit 113 notify the image object quantity comparative determination unit 115.

The image object quantity comparative determination unit 115 then compares the quantity of objects included in one high-priority image Im to the quantity of objects included in one low-priority image In and notifies the feature correction unit 121, configured as a portion of the image similarity calculation unit 114, of the image IDs of the high-priority image Im and low-priority image In whenever the quantities of objects therein are equal.

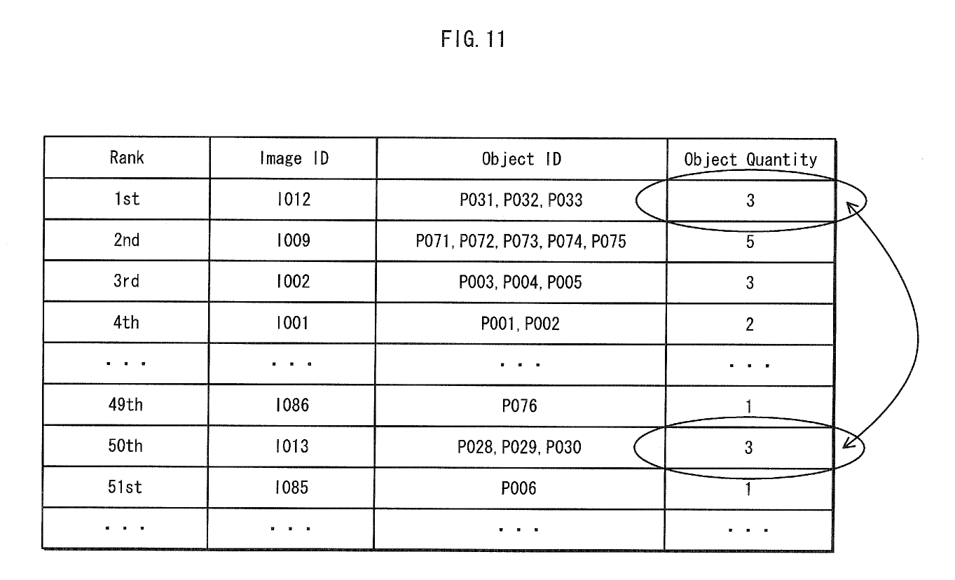

For example, as illustrated by FIG. 11, high-priority image I012 and low-priority image I012 are both found, upon comparison, to include three objects. In such cases, the image object quantity comparative determination unit 115 notifies the feature correction unit 121 of the image IDs of high-priority image I012 and low-priority image I013.

The image object quantity comparative determination unit 115 enables exclusion of certain low-priority images In from the object feature correction calculation, on the grounds that there is no possibility of the photographic subject thereof matching that of a high-priority image Im selected by the high-priority image selection unit 112.

1.13 Image Similarity Calculation Unit

The image similarity calculation unit 114 includes the feature correction unit 121, an image object similarity calculation unit 116, a similarity determination unit 123, and an average similarity calculation unit 122.

1.13.1 Feature Correction Unit

The feature correction unit 121 reads, from the object feature memory 104, the object features included in each high-priority image Im and low-priority image In having an image ID received by notification from the image object quantity comparative determination unit 115.

The feature correction unit 121 then corrects the object features of the objects included in low-priority image In by using a correction function F1 that takes the object features of the objects included in high-priority image Im and in low-priority image In as parameters.

Correction function F1 multiplies the feature vector components of an object included in a given low-priority image In by a correction coefficient. The correction coefficient is obtained from the ratio of the average of each feature vector components of the objects included in a given high-priority image Im to the average of each feature vector component of the objects included in the given low-priority image In.

In other words, let the feature vector of each object included in a given high-priority image Im received by notification from the image object quantity comparative determination unit 115 be given as Pu1(Pu11, Pu12 . . . Pu1n), Pi2(Pu21, Pu22 . . . Pu2n) Puv(Puv1, Puv2 . . . Puvn), let the feature vector of each object included in a given low-priority image In received by notification from the image object quantity comparative determination unit 115 be Pw1(Pw11, Pw12 . . . Pw1n), Pi2(Pw21, Pw22 . . . Pw2n) Pwv(Pwv1, Pwv2 . . . Pwvn), and let the post-correction feature vector Pw1, Pw2 . . . Pwn be Pw1a(Pw11a, Pw12a . . . Pw1na), Pw2a(Pw21a, Pw22a . . . Pw2na) Pwva(Pwv1a, Pwv2a . . . Pwvna). Correction function F1(P) is thus derived as the relational expression given in Math. 2, below.

$$Pwxa ( x = 1 , 2 , … , v ) = ( \begin{matrix}Pwx 1 a \\ Pwx 2 a \\ ⋮ \\ Pwxna\end{matrix} ) = F 1 ( Pux ( x = 1 , 2 , … , v ) ) = ( \begin{matrix}( ( {\sum }_{x = 1}^{v} Pux 1 ) / ( {\sum }_{x = 1}^{v} Pwx 1 ) ) \times Pwx 1 \\ ( ( {\sum }_{x = 1}^{v} Pux 2 ) / ( {\sum }_{x = 1}^{v} Pwx 2 ) ) \times Pwx 2 \\ ( ( {\sum }_{x = 1}^{v} Puxn ) / ( {\sum }_{x = 1}^{v} Pwxn ) ) \times Pwxn\end{matrix} ) ( x = 1 , 2 , … , v ) \qquad [ Math . 2 ]$$

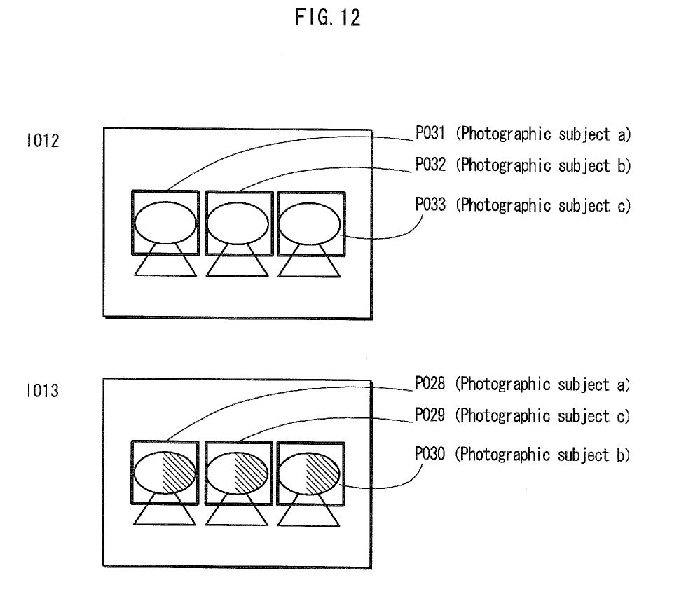

The following describes an example in which the image object quantity comparative determination unit 115 has notified the feature correction unit 121 of image ID I012 as a high-priority image and of image ID I013 as a low-priority image. As shown in FIG. 12, objects P031, P032, and P033 included in high-priority image I012 correspond to photographic subjects a, b, and c. Similarly, objects P028, P029, and P030 included in low-priority image I013 respectively correspond to photographic subjects b, c, and a.

Furthermore, a correction method that eliminates the effect of capture condition-driven noise or the like in the object features from the low-priority image 1013 is possible. For example, this method may involve selecting object P033, which is one of the objects included in high-priority image I012, then selecting P029, which corresponds to photographic subject c, from objects P028, P029, and P030 included in low-priority image I013 as corresponding to object P033, and using the object features of objects P033 and P029 to calculate the correction function. In such circumstances, the correspondence relationships between objects included in high-priority image I012 and in low-priority image I013 must be known. For instance, the content of the correction function is likely to vary between cases where the correction function is calculated using the object features of objects P033 and P029, both corresponding to the same photographic subject c, and cases where the correction function is calculated using the object features of object P033, which corresponds to photographic subject c, and of object P030, which corresponds to photographic subject a. In brief, the correspondence relationship between objects influences the correction function.

Nevertheless, difficulties abound in specifying whether each object included in image I012 corresponds to the photographic subject of an object in image I013.

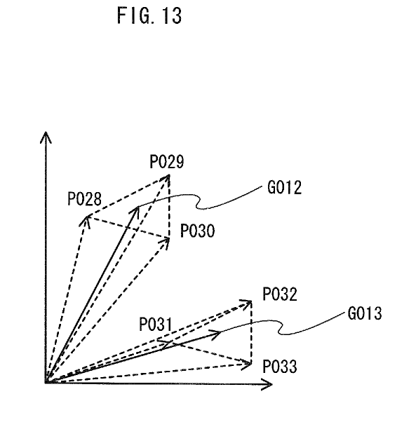

In the present Embodiment, as shown in FIG. 13, correction function F1 is calculated using central vector (average feature value vector) G012 of the object feature vectors for objects P031, P032, and P033 included in image I012, and central vector (average feature value vector) G013 of the object feature vectors for objects P028, P029, and P030 included in image I013. Accordingly, the feature correction unit 121 is able to calculate correction function F1 despite the lack of correspondence between the object vectors of objects P031, P032, and P033 included in high-priority image I012, the object vectors of objects P028, P029, and P030 included in low-priority image I013, and the photographic subjects a, b, and c. Accordingly, the processing load on the image management device is reduced as the process of drawing correspondences between the objects P031, P032, and P033 included in high-priority image I012 and the objects P028, P029, and P030 included in low-priority image I013 is skipped.

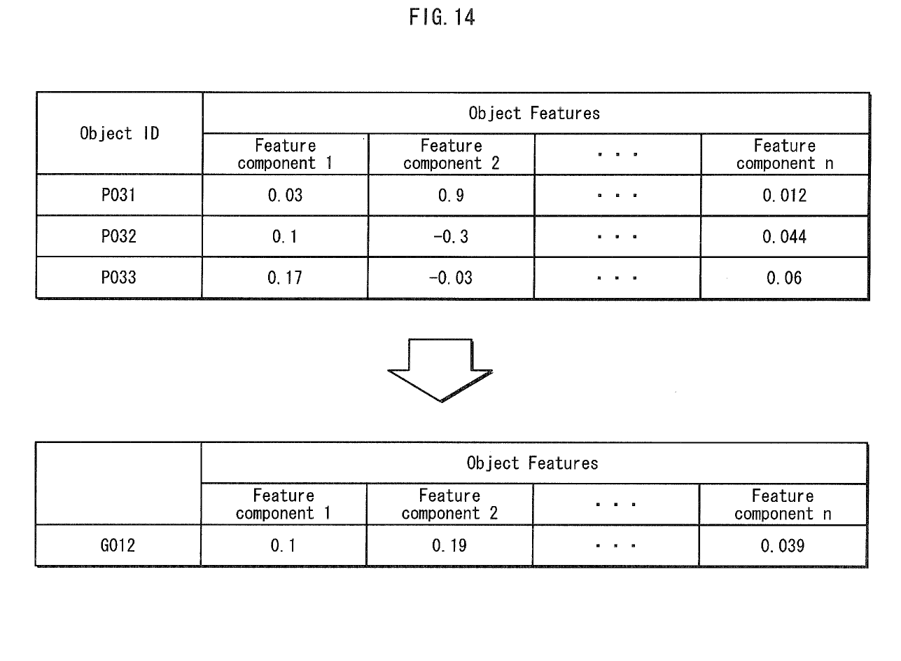

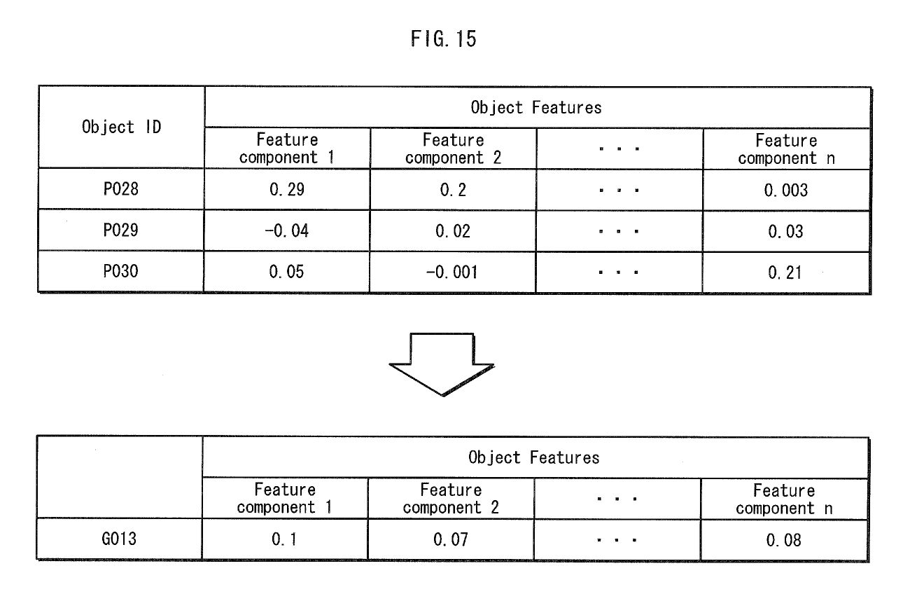

First, as illustrated by FIG. 14, the feature correction unit 121 calculates average feature value vector G012 (the central vector for the object feature vectors of objects P031, P032, and P033) from the object feature vectors of objects P031, P032, and P033 included in image I012. Then, as shown in FIG. 15, the feature correction unit 121 calculates average feature value vector G013 (the central vector for the object feature vectors of objects P028, P029, and P030) from the object feature vectors of objects P028, P029, and P030 included in image I013. For example, feature component 1 of average feature value vector G012 is calculated by averaging 0.03, which is feature component 1 of object P031, 0.1, which is feature component 1 of object P032, and 0.17, which is feature component 1 of object P030, for a result of 0.1 (=0.03+0.1+0.17/3).

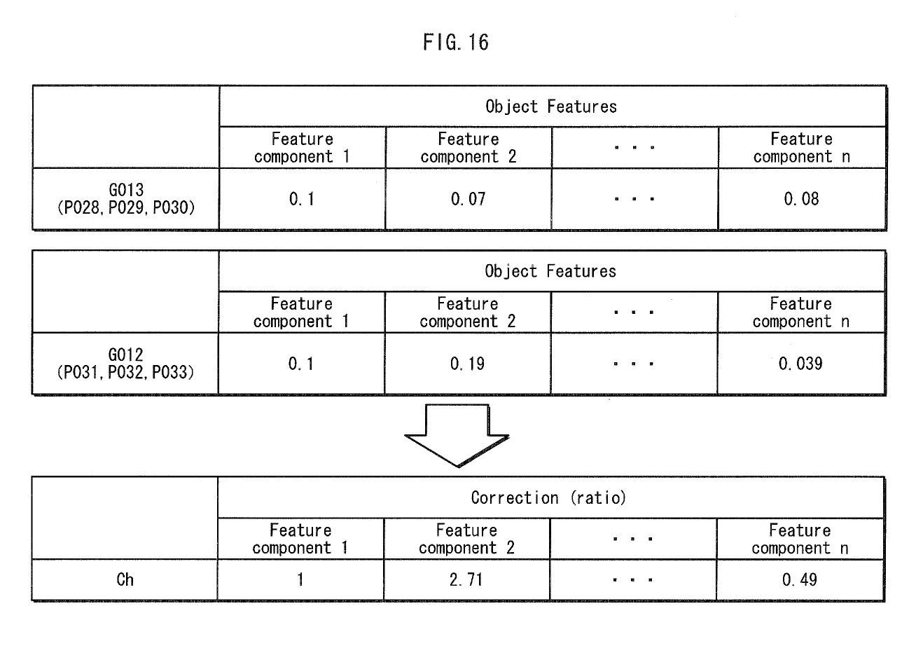

The feature correction unit 121 then calculates the correction coefficient by taking the ratio of each feature component in average feature value vector G012 to the corresponding feature component in average feature value vector G013, thus computing a correction vector Ch (see FIG. 16). Next, the feature correction unit 121 obtains correction function F1, which is a function multiplying each component of the correction vector Ch by the corresponding component of each feature vector P028, P029, and P030.

In brief, the feature correction unit 121 uses correction function F1 to correct the object feature vectors of objects P028, P029, and P030 included in low-priority image In. Thus, the effect of noise on low-priority image In can be eliminated without requiring correspondence between the objects included in image 1012 and in image I013.

When one of the feature components in average feature value vector G013 is zero, the feature correction unit 121 sets the corresponding feature component of correction vector Ch to one. Accordingly, divide-by-zero errors in feature components including zeroes are prevented from occurring.

The feature correction unit 121 outputs feature vectors P028a, P029a, and P030a, obtained using correction function F1 with feature vectors P028, P029, P030 as input, to the image object similarity calculation unit 116.

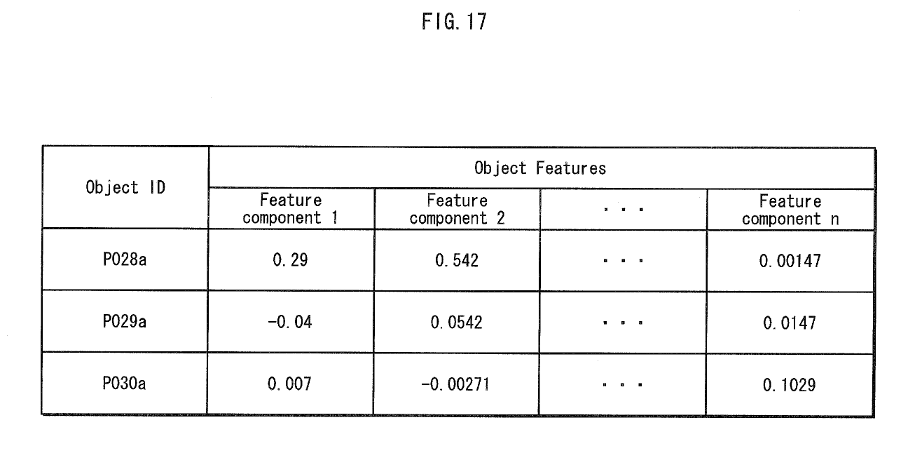

FIG. 17 lists the object features obtained by the feature correction unit 121 after corrections are applied to the object features using correction vector Ch, for the objects included in image I013.

1.13.2 Image Object Similarity Calculation Unit

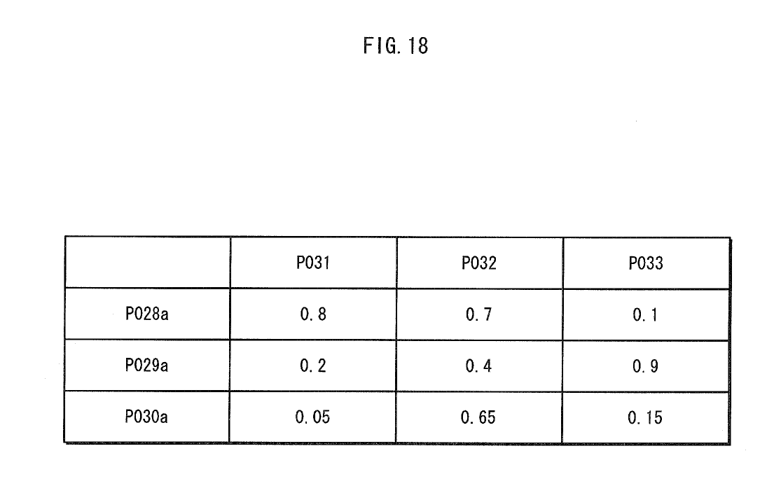

The image object similarity calculation unit 116 calculates a similarity (object similarity) between pairs formed from the plurality of objects included in high-priority image Im and the plurality of objects included in low-priority image In. The image object similarity calculation unit 116 calculates the object similarity between each pair using the object feature vectors of the objects included in image 1012 as obtained from the object feature memory 104, and the object feature vectors of the objects included in image I013 as input from the feature correction unit 121. Here, high-priority image I012 and low-priority image I013 each include three objects. Thus, object similarity is calculated for nine pairs of objects, as listed by FIG. 18. The image object similarity calculation unit 116 also calculates a cosine similarity using the object feature vectors of two contrasting objects. The object similarity for two given objects may also be calculated by taking the inner product of the feature vectors thereof.

That is, given an object Ps with object feature vector Ps(Ps1, Ps2 . . . Psn) and object Pt with object feature vector Pt(Pt1, Pt2 . . . Ptn), the similarity may be calculating using the relational expression given in Math. 3, below.

$$\frac{Ps \cdot Pt}{\vert Ps \vert \times \vert Pt \vert} = \frac{( \begin{matrix}Ps 1 \\ Ps 2 \\ ⋮ \\ Psn\end{matrix} ) \cdot ( \begin{matrix}Pt 1 \\ Pt 2 \\ ⋮ \\ Ptn\end{matrix} )}{\vert ( \begin{matrix}Ps 1 \\ Ps 2 \\ ⋮ \\ Psn\end{matrix} ) \vert \times \vert ( \begin{matrix}Pt 1 \\ Pt 2 \\ ⋮ \\ Ptn\end{matrix} ) \vert} \qquad [ Math . 3 ]$$

where |Ps| and |Pt| are the absolute values (norms) of feature vectors Ps and Pt, respectively.

FIG. 18 lists the results of calculating the similarity for objects P028a, P031, P032, and P033 using Math. 3.

Next, the image object similarity calculation unit 116 recognises pairs of objects P031, P032, and P033 and objects P028a, P029a, and P030a as representing a common photographic subject. This recognition is based on the calculated similarity therebetween. In other words, the image object similarity calculation unit 116 establishes a one-to-one correspondence, based on the object similarities as calculated, between objects P031, P032, and P033 included in high-priority image 1012 and objects P028, P029, and P030 (objects P028a, P029a, and P030a after correction) included in low-priority image I013.

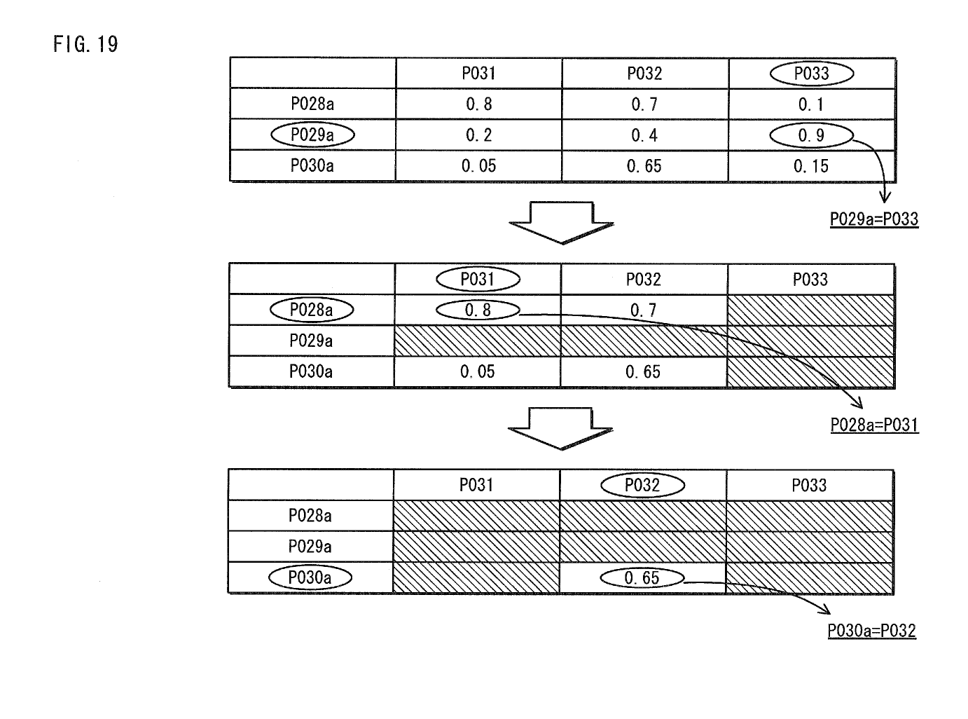

To this end, the image object similarity calculation unit 116 first detects the highest-similarity object pair (object P029a and object P033) among the calculated similarities, then recognizes object P029a and object P033 as representing the same photographic subject (see the top tier of FIG. 19). The image object similarity calculation unit 116 then detects the next highest-similarity object pair (object P028a and object P031) among the calculated similarities, excluding object P029a and object P033, and recognizes object P028a and object P031 as representing the same photographic subject (see the middle tier of FIG. 19). Finally, image object similarity calculation unit 116 recognizes the remaining objects (object P030a and object P032) as representing the same photographic subject (see the lower tier of FIG. 19).

The image object similarity calculation unit 116 then notifies the similarity determination unit 123 and the average similarity calculation unit 122 of the similarity for each pair of objects identified as representing the same photographic subject, i.e., each pair of objects for which a one-to-one correspondence is drawn. In the example of FIG. 18, the image object similarity calculation unit 116 notifies the similarity determination unit 123 and the average similarity calculation unit 122 of the 0.9 similarity between object P029a and P033, of the 0.8 similarity between object P028a and object P031, and of the 0.65 similarity between object P030a and object P032.

1.13.2 Similarity Determination Unit

The similarity determination unit 123 stores a threshold (similarity threshold) applicable to the object similarities. Upon receiving notification from the image object similarity calculation unit 116, the similarity determination unit 123 determines whether any of the object similarities surpass the threshold. Then, if any object similarity is below the threshold, the similarity determination unit 123 notifies the image selection unit 111 to such effect. For example, the similarity between two objects corresponding to different photographic subjects is below the similarity threshold. Conversely, upon determining that the similarities between all objects surpass the similarity threshold, the similarity determination unit 123 notifies the average similarity calculation unit 122 to such effect.

The similarity determination unit 123 extracts a plurality of objects corresponding to a common photographic subject included a plurality of images, and determines the similarity threshold according to a statistical similarity between objects. The plurality of images used to calculate the similarity threshold may be indicated by the user, using a (non-diagrammed) image selection unit provided by the image management device 100.

1.13.4 Average Similarity Calculation Unit

Upon receiving the notification from the image object similarity calculation unit 116, the average similarity calculation unit 122 calculates the average similarity of the objects, i.e., the average similarity of objects identified by the image object similarity calculation unit 116 as being in one-to-one correspondence. The average similarity calculation unit 122 then outputs the image similarity between high-priority image Im and low-priority image In to the image priority correction unit 117. For example, the image object similarity calculation unit 116 notifies the average similarity calculation unit 122 of object similarities 0.9, 0.8, and 0.65 (see FIG. 19). The average similarity calculation unit 122 then calculates the average object similarity thereof (i.e., (0.9+0.8+0.65)/3=0.78) and notifies the image priority correction unit 117 of the image similarity for high-priority image I012 and low-priority image I013.

1.14 Image Priority Correction Unit

The image priority correction unit 117 corrects the image priority of low-priority image In using the similarity output by the average similarity calculation unit 122, which is configured as part of the image similarity calculation unit 114, and the image priority of high-priority image Im and low-priority image In as stored in the image priority memory 323.

That is, the image priority correction unit 117 uses the relational expression given by Math. 4, below, to calculate a new image priority Scn′ for low-priority image In by correcting the image priority Scn thereof. In Math. 4, Sg represents the image similarity, Scm represents the image priority of high-priority image Im, and Scn represents the image priority of low-priority image In.

Scn′=(Scm−Scn)×Sg+Scn [Math. 4]

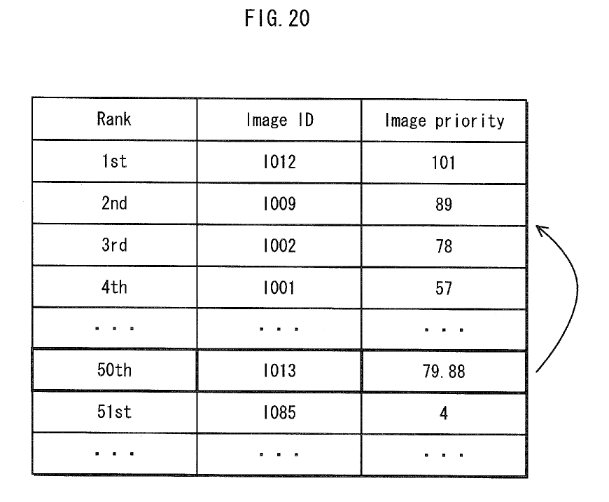

For example, let the image priority of high-priority image I012 be 101, the image priority of low-priority image I013 be 5, and the image similarity between high-priority image I012 and low-priority image I013 be 0.78. The image priority correction unit 117 accordingly corrects the image priority of low-priority image In to (101−5)×0.78+5=79.88 (see FIG. 20).

The image priority correction unit 117 also stores image priority Scn′ as calculated in the image priority memory 323, and notifies the image selection unit 111 and the image re-ranking unit 118 to the effect that correction is complete.

1.15 Image Re-Ranking Unit

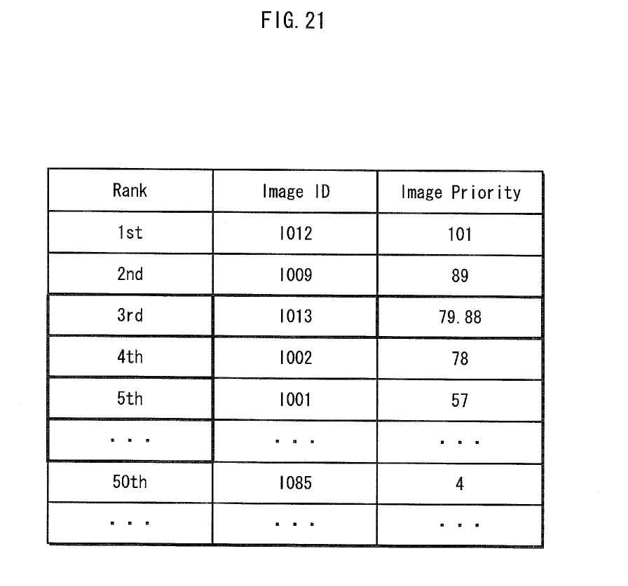

The image re-ranking unit 118 obtains the image priority of each image from the image priority memory 323 and re-ranks the images accordingly (see FIG. 21). The image re-ranking unit 118 then notifies the image output unit 119 of the re-ranking so calculated.

1.16 Image Output Unit

The image output unit 119, which is connected to the display device 120 through the HDMI output terminal, generates image ranking data composed of image ranking information for the images, based on the rank thereof as calculated by the image re-ranking unit 118, and outputs the image ranking data via the HDMI output terminal. The display device 120 then displays the image ranking data output from the image output unit 119 (see FIG. 21).

2. Operations

2.1 Overall Operations

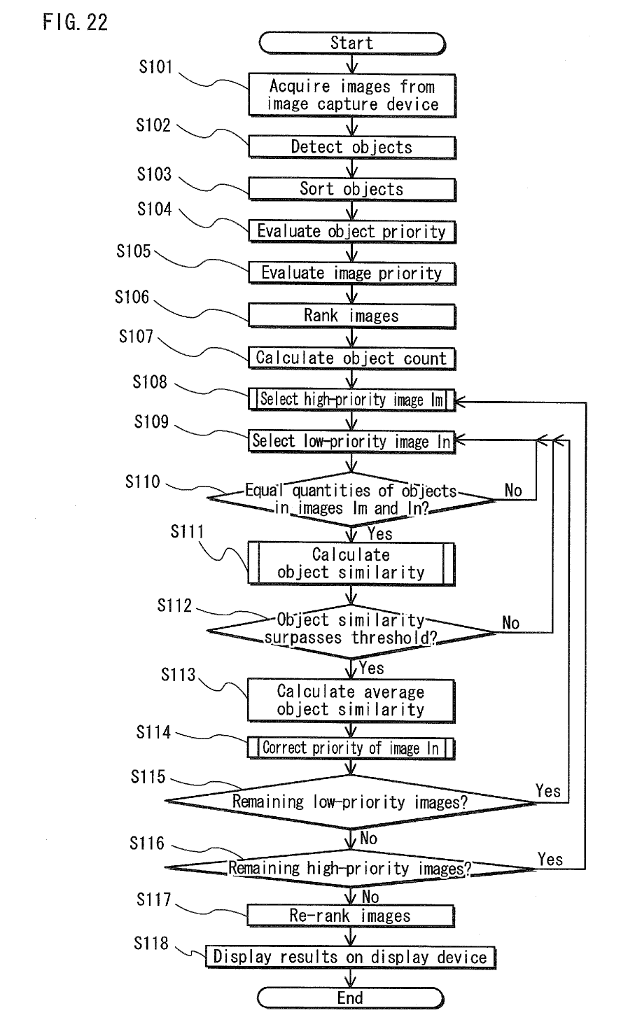

FIG. 22 is a flowchart representing the operations of the image management device 100 pertaining to Embodiment 1.

The image acquisition unit 102 acquires a plurality of images stored in the image capture device 101 and assigns an image ID to each image (step S101). In the example of FIG. 2, image IDs 1001, 1002, 1003, 1004, and so on are assigned in order of acquisition.

Next, the object detection unit 103 detects objects in each of the images 1001, 1002, and so on acquired by the image acquisition unit 102 and assigns an object ID to each detected object (see FIGS. 3 and 4).

The object detection unit 103 then stores the object feature vector for each object, in correspondence with the object ID, in the object feature memory 104 (see FIG. 5) (step S102).

The object sorting unit 105 subsequently sorts all objects detected by the object detection unit 103 into one of a plurality of clusters according to the object feature vector of each object as stored in the object feature memory 104. The object sorting unit 105 then notifies the object priority calculation unit 106 of the quantity of objects belonging to each cluster (see FIG. 6) (step S103).

Next, the object priority calculation unit 106 specifies a cluster ID identifying the cluster to which each object belongs and outputs the quantity of objects as the object priority (see FIG. 6) (step S104).

The image priority calculation unit 107 then calculates the image priority of each image according to the object priority calculated by the object priority calculation unit 106 (step S105). The image priority calculation unit 107 computes the image priority of a given image by taking the sum of the object priority for all objects included therein (see FIG. 8). The image priority calculation unit 107 then notifies the image ranking unit 108 of the image priority thus calculated. The image priority calculation unit 107 similarly notifies the image priority memory 323 of the image priority thus calculated (see FIG. 9).

Afterward, the image ranking unit 108 ranks the images according to the image priority obtained from the image priority memory 323 for each image (see FIG. 10) (step S106). The image ranking unit 108 also notifies the image object quantity extraction unit 109 upon completion of the image ranking and notifies the image selection unit 111 of the ranking results.

Upon receiving notification from the image ranking unit 108 that image ranking is complete, the image object quantity extraction unit 109 calculates the quantity of objects included in each image according to the quantity of object IDs received by notification from the image priority calculation unit 107 (see FIG. 11). The image object quantity extraction unit 109 then stores the result, in correspondence with the image IDs, in the image object quantity memory 110 (step S107).

Next, the high-priority image selection unit 112, which is configured as part of the image selection unit 111, sequentially selects image I012, ranked first, and so on until reaching the image ranked Mth (49th in FIG. 10), as high-priority images Im among the plurality of ranked images (step S108). The details of image priority Im selection are described later, in section 2.4. The high-priority image selection unit 112 then notifies the image object quantity comparative determination unit 115 of the image ID of a given high-priority image Im. For example, the high-priority image selection unit 112 notifies the image object quantity comparative determination unit 115 of image ID I012, belonging to the image ranked first.

Subsequently, the low-priority image selection unit 113, configured as a portion of the image selection unit 111 sequentially selects the images ranked M+1th (50th in FIG. 10) and so on until reaching the image ranked last, as low-priority images In among the ranked images. The low-priority image selection unit 113 then notifies the image object quantity comparative determination unit 115 of the image ID of a given low-priority image In. For example, the low-priority image selection unit 113 notifies the image object quantity comparative determination unit 115 of image ID I013, belonging to the image ranked 50th.

Next, the image object quantity comparative determination unit 115 compares the quantity of objects included in high-priority image I012 to the quantity of objects included in low-image priority image I013 to determine whether or not the quantities are equal (step S110). This determination is made according to the image ID (of image I012) received by notification from the high-priority image selection unit 112, the image ID (of image I013) received by notification from the low-priority image selection unit 113, and information pertaining to the quantity of objects included in each image as stored in the image object quantity memory 110.

Upon determining, in step S110, that the respective quantities of objects included in high-priority image I012 and in low-priority image I013 are different (No in step S110), the image object quantity comparative determination unit 115 notifies the image selection unit 111 to such effect. When the image selection unit 111 receives such a notification, the low-priority image selection unit 113, which is configured as a portion of the image selection unit 111, selects a different image as the low-priority image In (step S109).

In contrast, upon determining, in step S110, that the respective quantities of objects included in high-priority image I012 and in low-priority image I013 are identical (Yes in step S110), the image object quantity comparative determination unit 115 notifies the image similarity calculation unit 114 of the image IDs of high-priority image I012 and low-priority image I013.

Upon receiving the image IDs of high-priority image I012 and low-priority image I013 from the image object quantity comparative determination unit 115, the image similarity calculation unit 114 calculates an object similarity for each pair, using the respective object feature vectors of objects P031, P032, and P033 included in high-priority image I012 and of objects P028, P029, and P030 included in low-priority image I013, as calculated by the feature correction unit 221 and the image object similarity calculation unit 116 (step S111). The details of the object similarity calculation process are described later, in section 2.2.

Next, the similarity determination unit 123 determines whether the object similarities thus calculated surpass a predetermined similarity threshold (step S112).

Upon determining that one or more of the object similarities thus calculated are lower than the similarity threshold (No in step S112), the similarity determination unit 123 notifies the low-priority image selection unit 113 to such effect. The low-priority image selection unit 113 then selects another low-priority image (step S109).

Conversely, upon determining that all object similarity thus calculated meets or surpasses the similarity threshold (Yes in step S112), the similarity determination unit 123 notifies the average similarity calculation unit 122 to such effect. Consequently, the average similarity calculation unit 122 calculates the average object similarity and notifies the image priority correction unit 117 of the resulting value as the image similarity (step S113). The image priority correction unit 117 then corrects the image priority of low-priority image I013 according to the image similarity thus calculated (step S114). The sequence of image priority correction operations is described later, in section 2.3. Upon completing the image priority correction for image I013, the image priority correction unit 117 stores the result in the image priority memory 323, and notifies the image re-ranking unit 118 and the image selection unit 111 of correction completion.

Upon receiving the notification of correction completion from the image priority correction unit 117, the image selection unit 111 checks whether or not any images ranked lower than previously-selected image I013 remain (step S115).

Upon determining, in step S115, that such images do remain (Yes in step S115), the low-priority image selection unit 113 selects an image ranked lower than image I013. For example, having previously selected image I013, ranked 50th, the low-priority image selection unit 113 next selects image I085, ranked 51st (see FIG. 11).

On the other hand, when the low-priority image selection unit 113 determines, in step S115, that no images ranked lower than previously-selected image In remain (No in step S115), the high-priority image selection unit 112 checks whether or not any images ranked lower than previously-selected image I012 remain (step S116).

Upon determining, in step S116, that such images do remain (Yes in step S116), the high-priority image selection unit 112 selects an image ranked lower than image I012. For example, having previously selected image I012, ranked 1st, the high-priority image selection unit 112 next selects image I009, ranked 2nd (see FIG. 11).

On the other hand, when the high-priority image selection unit 112 determines, in step S116, that no images ranked lower than previously-selected image Im remain (No in step S116), the image re-ranking unit 118 re-ranks the images using the image priority evaluated by the image priority calculation unit 107 and the corrected priority calculated by the image priority correction unit 117 (step S117). The image re-ranking unit 118 re-ranks the images in descending order of image priority. FIG. 21 lists an example thereof. In the example of FIG. 21, the image priority of image I013 has been corrected from 5 to 79.88. Image I013 is therefore re-ranked 3rd.

Finally, the image output unit 119 outputs the re-ranking results produced by the image re-ranking unit 118 to the display device 120 (step S118).

2.2 Object Similarity Calculation

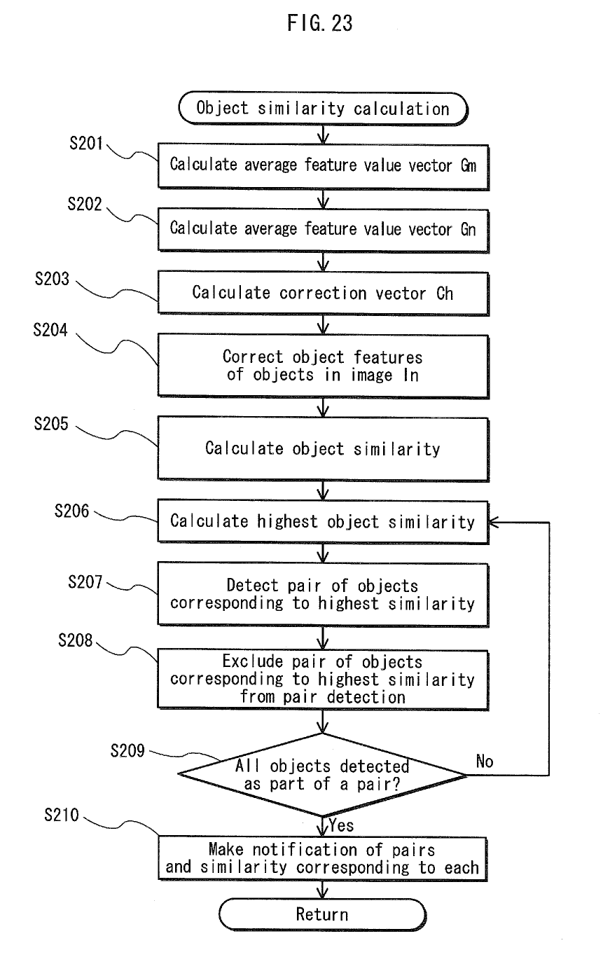

FIG. 23 is a flowchart of the object similarity calculation process.

First, average feature value vector Gm is calculated for the objects included in high-priority image Im (the following example describes average feature value vector G012 of objects P031, P032, and P033 included in image I012) (step S201).

Next, average feature value vector Gn is calculated for the objects included in low-priority image In (the following example describes average feature value vector G013 of objects P028, P029, and P030 included in image I013) (step S202).

Subsequently, correction vector Ch is computed from average feature value vector G012 and average feature value vector G013 (step S203).

The feature correction unit 121 then computes a feature vector for each object P028a, P029a, and P030a obtained by correcting objects P028, P029, and P030 included in low-priority image I013. The correction is performed by applying correction function F1 as given by Math. 1, above, using correction vector Ch (step S204).

Next, the image object similarity calculation unit 116 calculates the similarity between each object P031, P032, and P033 included in high-priority image I012 and each corrected object P028a, P029a, and P030a (step S205).

The image object similarity calculation unit 116 then extracts the highest similarity among all those calculated (step S206).

The image object similarity calculation unit 116 thus detects pairs of objects having correspondingly high similarities (step S207). In the example of FIG. 19, the image object similarity calculation unit 116 detects object P029a and object P033 as a pair (step S208).

Here, given that the image object similarity calculation unit 116 has detected objects P029a and P033 as a pair, the two objects are excluded from further pair detection. In the example of FIG. 19, hatched portions represent similarities excluded from pair detection.

The image object similarity calculation unit 116 then determines whether or not all objects have been subject to pair detection (step S209).

In the negative case, the image object similarity calculation unit 116 returns to step S206.

In the affirmative case, the image object similarity calculation unit 116 notifies the average similarity calculation unit 122 of the object pairs and of the corresponding similarity (step S210). In this example, the image object similarity calculation unit 116 notifies the average similarity calculation unit 122 that the similarity between objects P029a and P033 is 0.9, that the similarity between objects P028a and P031 is 0.8, and that the similarity between objects P030a and P032 is 0.65 (see FIG. 19).

2.3 Image Priority Correction

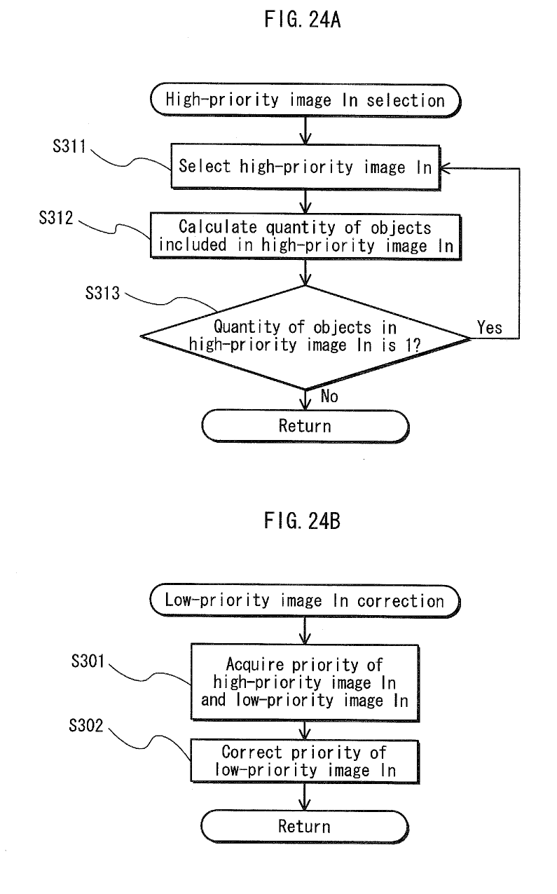

FIG. 24A is a flowchart of the image priority correction process.

First, the image priority correction unit obtains the image priority of images I012 and I013 from the image priority memory 323 (step S301). Here, the image priority of image I012 is 101 and that of image I013 is 5 (see FIG. 9).

Subsequently, the image priority correction unit 117 first computes the difference between 101, which is the image priority of image I012, and 5, which is the image priority of image I013, then takes the product of this difference and 0.78, which is the average similarity of the pair of objects. Next, the image priority correction unit 117 calculates the sum of this product and the image priority of low-priority image I013, then outputs the result of 79.88 as the new image priority of image I013 (see FIG. 20) (step S302).

2.4 High-Priority Image Selection

FIG. 24A is a flowchart of the high-priority image Im selection process.

First, the high-priority image selection unit 112 selects a single high-priority image Im (step S311).

Next, the high-priority image selection unit 112 calculates the total quantity of object IDs received by notification from the image priority calculation unit 107 for the selected high-priority image Im (step S312).

Subsequently, the high-priority image selection unit 112 determines whether or not the quantity of objects included in the selected high-priority image Im is one (step S313).

Upon determining, in step S313, that only one object is included in the selected high-priority image Im (Yes in step S313), the high-priority image selection unit 112 selects another high-priority image Im (step S311).

Conversely, upon determining, in step S313, that the selected high-priority image Im includes a plurality of objects (No in step S313), the high-priority image selection unit 112 ends the high-priority image Im selection process.

### Embodiment 2

1. Configuration

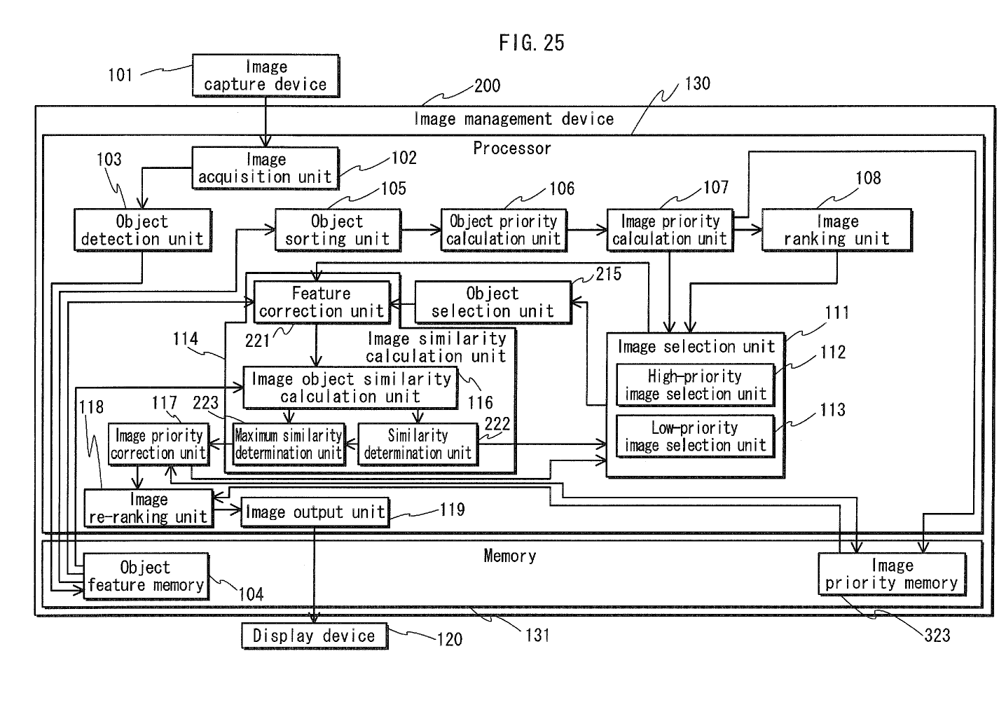

An image management device 200 pertaining to the present Embodiment is configured substantially similarly to FIG. 1, differing only in the inclusion of an object selection unit 215, and in that the image similarity calculation unit 114 further includes a maximum similarity calculation unit 223. These points of difference are shown in FIG. 25. Components identical to those of FIG. 1 use the same reference numbers, and explanations thereof are omitted below.

1.1 Object Selection Unit

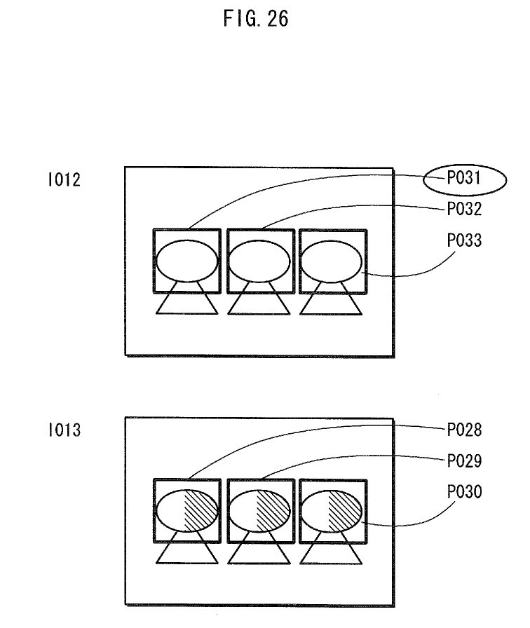

The object selection unit 215 selects one object among the objects included in high-priority image Im, selected by the high-priority image selection unit 112, and notifies the feature correction unit 221 of the object ID of the selected object and of the image ID of the image in which the selected object is included. For example, as illustrated by FIG. 26, the object selection unit 215 selects object P031 among objects P031, P032, and P033 included in high-priority image I012, then notifies the feature correction unit 221 of the object ID of object P031 and of the image ID of high-priority image I012.

1.2 Image Similarity Calculation Unit

The image similarity calculation unit 114 includes a feature correction unit 221, the image object similarity calculation unit 116, the maximum similarity calculation unit 223, and a similarity determination unit 222.

1.2.1 Feature Correction Unit

The feature correction unit 221 reads out the object feature vectors of object P031, specified by the object ID received by notification from the object selection unit 215, and of objects P028, P029, and P030, all included in low-priority image I013 and specified by the image ID received by notification from the image selection unit 111. The object vectors are read out from the object feature memory 104.

The feature correction unit 221 then corrects the object feature vector of each object included in low-priority image In read out from the object feature memory 104 and outputs the result. This correction is performed using correction function F2, which takes the object feature vector of an object included in high-priority image Im and the object feature vector of an object included in low-priority image In as parameters.

Correction function F2 multiplies the object features of each object included in low-priority image In by a correction coefficient. The correction coefficient is obtained from the ratio of the object feature vector of a selected object included in high-priority image Im to the feature vector of an object included in low-priority image In.

In other words, let the object feature vector of the selected object included in high-priority image Im be Puy(Puy1, Puy2 . . . Puyn), let the object feature vectors of the objects included in low-priority image In be Pw1(Pw11, Pw12 . . . Pw1n), Pw2(Pw21, Pw22 . . . Pw2n) Pwv(Pwv1, Pwv2 . . . Pwvn), and let the post-correction feature vectors Pw1, Pw2 . . . Pwv be Pwlby(Pw11by, . . . Pw12by . . . Pw1nby), Pw2b(Pw21by, Pw22by . . . Pw2nby) Pwvby(Pwv1by, Pwv2by . . . Pwvnby). Correction function F2(P) is thus the relational expression given by Math. 5.

$$Pwxby ( x = 1 , 2 , … , v ; y = 1 , 2 , … , z ) = ( \begin{matrix}Pwx 1 by \\ Pwx 2 by \\ ⋮ \\ Pwxnby\end{matrix} ) = F 2 ( Pux ( x = 1 , 2 , … , v ; r = 1 , 2 , … , v ; y = 1 , 2 , … , z ) ) = ( \begin{matrix}( Puy 1 / Pwr 1 ) \times Pwx 1 \\ ( Puy 2 / Pwr 2 ) \times Pwx 2 \\ ( Puyn / Pwrn ) \times Pwxn\end{matrix} ) ( x = 1 , 2 , … , v ) \qquad [ Math . 5 ]$$

The present example discusses a case where the feature correction unit 221 receives a notification from the object selection unit 215 that includes the image ID of high-priority image I012, the object ID of object P031, and the image ID of low-priority image I013.

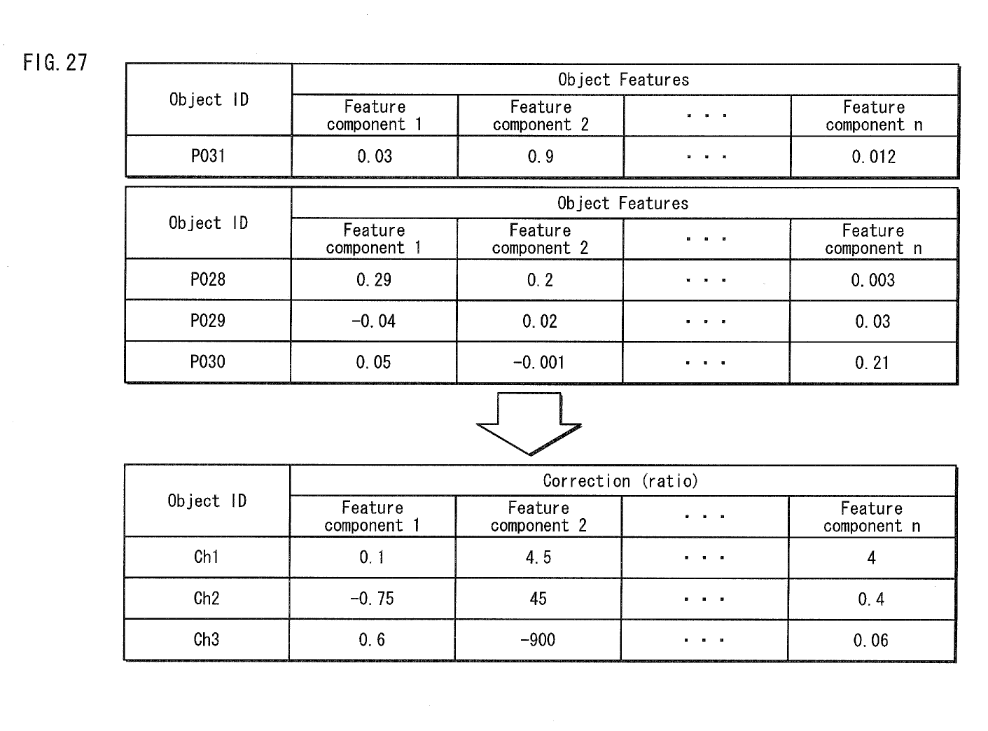

The feature correction unit 221 calculates the correction coefficient by taking the ratio of each feature component of the object vectors of objects P028, P029, and P030 included in image I013 to each feature component of object P03, and computes correction vectors Ch1, Ch2, and Ch3 accordingly (see FIG. 27).

Whenever a feature component in the object feature vector of any of objects P028, P029, and P030 is zero, the feature correction unit 121 sets the corresponding feature component of correction vector Ch, Ch2, or Ch3 to one. Accordingly, divide-by-zero errors in feature components including zeroes are prevented from occurring.

The feature correction unit 221 then obtains correction function F2 as a function multiplying each component of correction vectors Ch1, Ch2, and Ch3 by the corresponding component of each feature vector P028, P029, and P030.

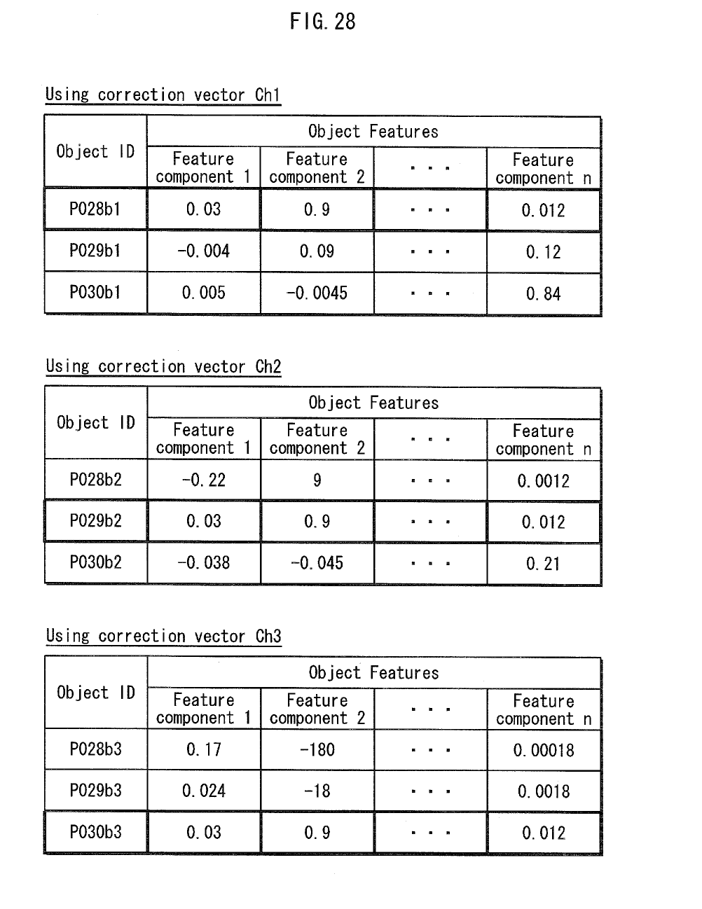

The feature correction unit 221 also notifies the image object similarity calculation unit 116 of the object feature vectors for each object obtained by taking the respective objects P028, P029, and P030 as input in correction function F2, namely objects P028b1, P029b1, P030b1, P028b2, P029b2, P030b2, P028b3, P029b3, and P030b3 (see FIG. 28). When correction vector Ch1 (or Ch2, Ch3) is used, correction function F2 makes corrections according to the assumption that object P031 and object P028 (or P029, P030) have a common photographic subject.

1.2.2 Image Object Similarity Calculation Unit

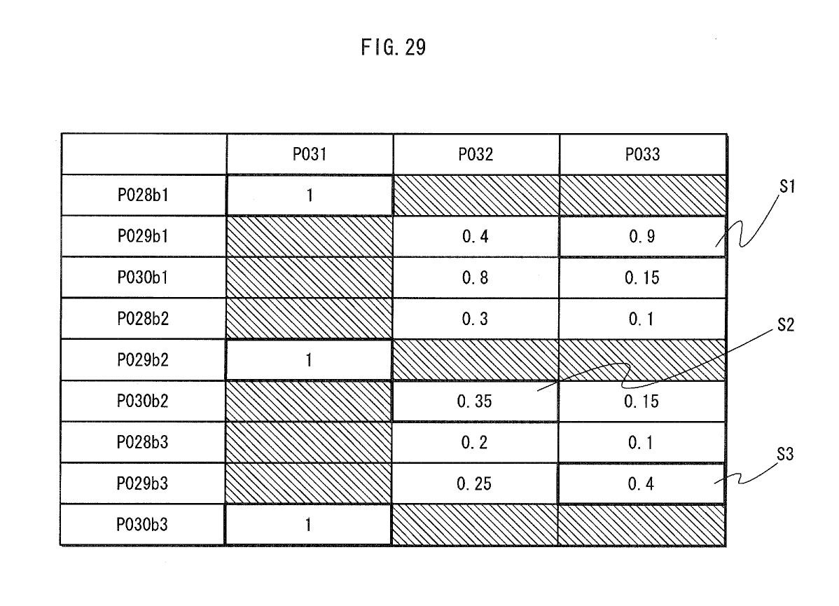

The image object similarity calculation unit 116 calculates the respective similarities between object pair P032 and P033 and object pair P029b1 and P030b1, between object pair P032 and P033 and object pair P028b2 and P030b2, and between object pair P032 and P033 and object pair P028b3 and P029b3 (see FIG. 29). The former pairs are included in image I012 while the latter pairs are received by notification from the feature correction unit 221. That is, the image object similarity calculation unit 116 calculates the similarities between pairs of objects not used in the calculation of correction function F2. Accordingly, the processing load on the image object similarity calculation unit 116 is reduced for object similarity calculation.

The image object similarity calculation unit 116 also extracts the strongest similarity among those calculated between objects P032 and P033 and objects P029b1 and P030b1 as maximum similarity S1. In the example of FIG. 29, the similarity between object P033 and object P029b1 is 0.9. Then, the maximum similarity calculation unit 223 extracts the next-highest similarity among those calculated between objects P032 and P033 and objects P028b2 and P030b2 as maximum similarity S2. In the example of FIG. 27, the similarity between object P032 and object P030b2 is 0.35. The image object similarity calculation unit 116 further extracts the next-highest similarity among those calculated between objects P032 and P033 and objects P028b3 and P029b3 as a maximum similarity S3. In the example of FIG. 29, the similarity between object P033 and object P029b3 is 0.4.

Afterward, the image object similarity calculation unit 116 extracts the highest similarity among the extracted similarities S1, S2, and S3, thereby detecting pairs of objects indicated thereby. In the example of FIG. 27, the image object similarity calculation unit 116 extracts similarity S1 (0.9), and the pair corresponding to similarity S1 is made up of objects P033 and P029b1. The image object similarity calculation unit 116 also extracts the similarity between objects P032 and P029b2 (0.8 in the example of FIG. 29) which are objects other than the pair of objects related to similarity S1, namely objects P033 and P029b1. The maximum similarity calculation unit 223 then notifies the similarity determination unit 222 of the extracted similarities.

1.2.3 Similarity Determination Unit

The similarity determination unit 222 stores a predetermined threshold pertaining to similarity (similarity threshold), and determines whether or not the similarities received by notification from the maximum similarity calculation unit 223 surpass the similarity threshold. Then, if any of the object similarities is below the threshold, the similarity determination unit 222 notifies the image selection unit 111 to such effect. Conversely, upon determining that the similarities of all objects surpass the similarity threshold, the similarity determination unit 123 notifies the maximum similarity calculation unit 223 to such effect.

1.2.4 Maximum Similarity Calculation Unit

The maximum similarity calculation unit 223 calculates the highest similarity among the similarities received by notification from the image object similarity calculation unit 116 and notifies the image priority correction unit 117 accordingly. In the example of FIG. 29, the maximum similarity calculation unit 223 calculates the highest similarity among the similarities respectively calculated between objects P032 and P030b1 and between objects P033 and P029b1.

2. Operations

2.1 Overall Operations

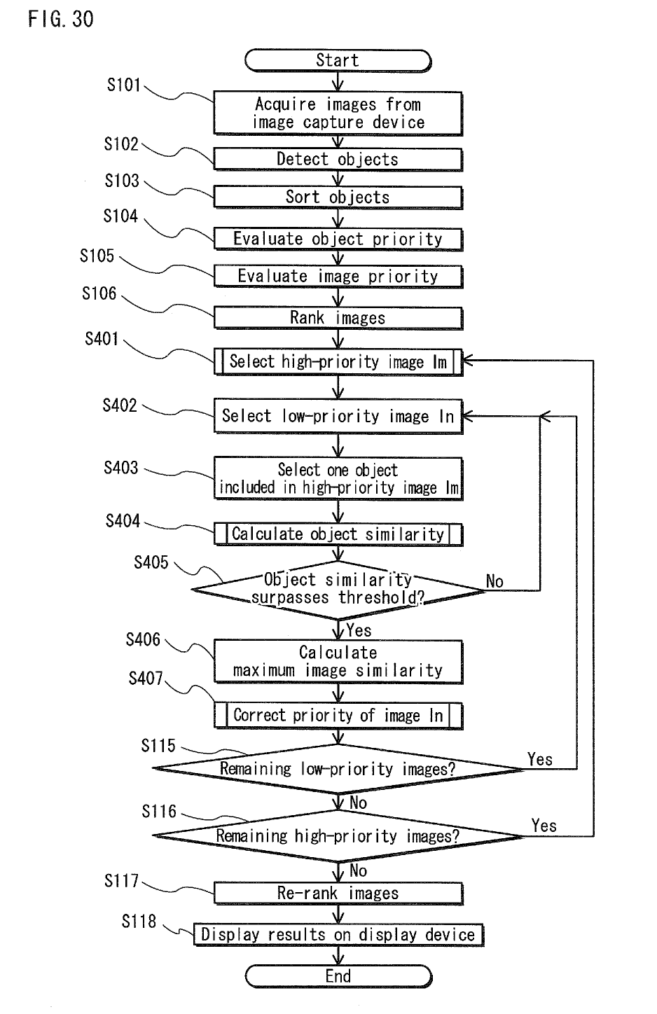

FIG. 30 is a flowchart representing the operations of the image management device 200 pertaining to Embodiment 2. The overall operations of the present Embodiment differ from those of Embodiment 1 between steps S106 and S114. Given that all other steps are identical to those of Embodiment 1, explanations thereof are omitted.

After ranking the image priorities in step S106, the image management device 200 pertaining to the present Embodiment has the high-priority image selection unit 112, configured as a part of the image selection unit 111, select image I012, ranked first, through image I086, ranked. Mth (in FIG. 10, M=49), thus selecting a plurality of high-priority images Im among the ranked images (step S401). The high-priority image selection unit 112 also notifies the object selection unit 215 of the image ID of a given high-priority image Im thus selected. For example, the high-priority image selection unit 112 notifies the object selection unit 215 of image ID I012, belonging to high-priority image I012 which is the image ranked first.

Next, the low-priority image selection unit 113, configured as a portion of the image selection unit 111, sequentially selects the image ranked M+1th (50th in FIG. 10) and so on until reaching the image ranked last, thus selecting a plurality of low-priority images In among the ranked images (step S402). The details of the image priority Im selection process are described in Embodiment 1 and are thus omitted (see step S108 of FIG. 22). The low-priority image selection unit 113 notifies the object selection unit 215 of the image ID of a given low-priority image In. For example, the low-priority image selection unit 113 notifies the object selection unit 215 of image ID I013, belonging to the image ranked 50th.

Next, the object selection unit 215 selects one object included in high-priority image Im, in accordance with the image ID of the given high-priority image Im received by notification from the high-priority image selection unit 112 (step S403). In the example of FIG. 26, object P031 is selected. The object selection unit 215 then notifies the image similarity calculation unit 114 of the image ID of image I012 and of the object ID of object P031 included therein.

Subsequently, the image similarity calculation unit 114 calculates object similarities according to the object feature vectors of objects P031, P032, and P033 included in high-priority image I012 and the object feature vectors of objects P028, P029, and P030 included in low-priority image I013 (see FIG. 29). This calculation is performed by the feature correction unit 221 and the image object similarity calculation unit 116 (step S404). The details of the object similarity calculation process for the objects included in high-priority image I012 and in low-priority image I013 are described later, in section 2.2.

Next, the similarity determination unit 222 determines whether or not all similarity calculated by the image object similarity calculation unit 116 surpasses the pre-set similarity threshold (step S405).

Upon determining that some calculated object similarity does not meet the pre-set similarity threshold (No in step S405), the similarity determination unit 222 notifies the image selection unit 111 to such effect. The low-priority image selection unit 113, being configured as a portion of the image selection unit 111, selects another low-priority image that is not image I013 (step S402).

Conversely, upon determining that all object similarity calculated by the image object similarity calculation unit 116 surpasses the pre-set similarity threshold (Yes in step S405), the maximum similarity calculation unit 223 takes the highest similarity among the calculated object similarities and outputs the value thereof as the image similarity (step S406).

Next, the image priority correction unit 117 corrects the image priority of low-priority image I013 according to the image similarity output by the maximum similarity calculation unit 223 and the image priority of high-priority image I013 and of low-priority image I012 obtained from the image priority memory 323 (step S407) The sequence of image priority correction operations is described later, in section 2.3.

2.2 Object Similarity Calculation

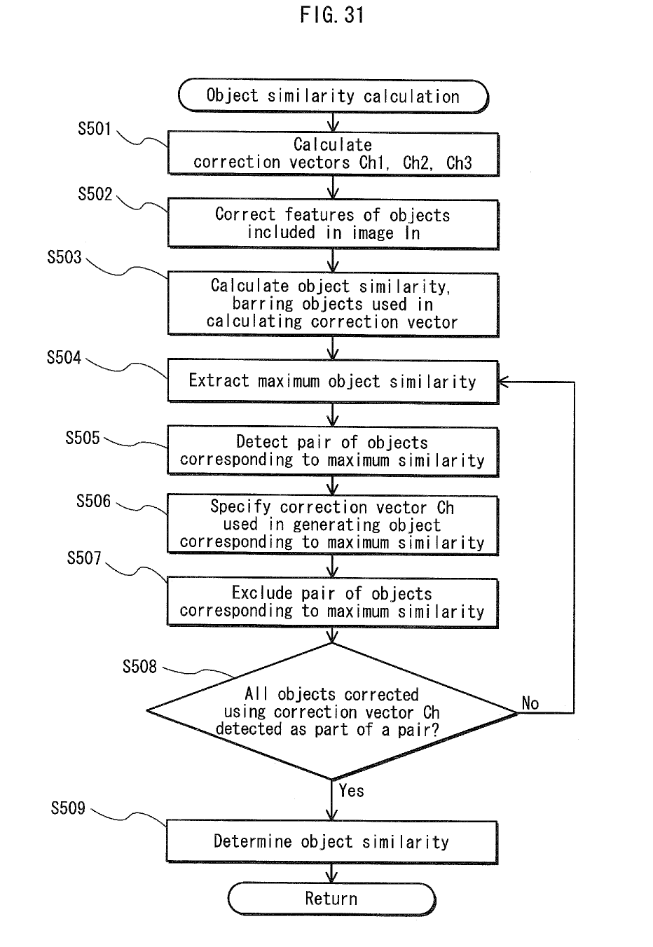

FIG. 31 is a flowchart of the object similarity calculation process.

First, the feature correction unit 221 calculates the correction vector according to the image ID and object ID received by notification from the object selection unit 215 (step S501). Here, the image object similarity calculation unit 116 calculates correction vectors Ch1, Ch2, and Ch3 from a correction coefficient obtained by taking the ratio of each feature component of object P031, included in image I012, to each feature component of objects P028, P029, and P030, included in image I013 (see FIG. 27).

Next, the feature correction unit 221 corrects the object features of objects P028, P029, and P030, included in image In (image I013), using correction vectors Ch1, Ch2, and Ch3 to generate objects P029b1, P030b1, P028b2, P030b2, P029b3, and P030b3 (see FIG. 28) (step S502).

The image object similarity calculation unit 116 then calculates the similarity between all pairs of objects, to the exception of the objects used in calculating each correction vector Ch1, Ch2, and Ch3 (see FIG. 29) (step S503).

Next, the image object similarity calculation unit 116 extracts the highest similarity among those thus calculated (step S504). In the example of FIG. 29, the similarity between object P033 and object P029b1 is highest. The image object similarity calculation unit 116 then detects the pair of objects corresponding to this highest similarity (step S505) and specifies the correction vector used to generate one member of the pair (step S506). In this example, correction vector Ch1 is specified as used to generate object P029b1.

Next, the image object similarity calculation unit 116 excludes the pair of objects corresponding to the highest similarity (step S507), and determines whether or not all objects generated using correction vector Ch1 have been subject to pair detection (step S508).

Upon determining, in step S508, that objects generated using correction vector Ch1 have not been subject to pair detection (No in step S508), the image object similarity calculation unit 116 repeats the highest similarity extraction process (step S504).

Conversely, upon determining, in step S508, that all objects generated using correction vector Ch1 have been subject to pair detection (Yes in step S508), the image object similarity calculation unit 116 notifies the maximum similarity calculation unit 223 of each pair of objects and of the similarity corresponding thereto (step S509).

2.3 Image Priority Correction

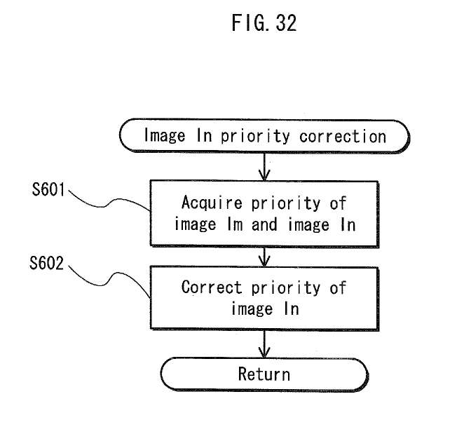

FIG. 32 is a flowchart of the image priority correction process.

First, the image priority correction unit 117 acquires the image priority of image I012 and image I013 from the image priority memory 323 (step S601). Here, the image priority of image I012 is 101, and the image priority of image I013 is 5.

Subsequently, the image priority correction unit 117 computes a new image priority for image I013 by taking the product of 0.9, which is the image similarity received by notification from the maximum similarity calculation unit 223, and the difference between the image priority of images I012 and image I013, respectively 101 and 5, then adding the image priority of image I013 to this product (step S602).

### Embodiment 3

1. Configuration

The image management device pertaining to the present Embodiment is configured to be substantially similar to FIG. 1, differing only in the function of the image similarity calculation unit 114. Components identical to those of FIG. 1 use the same reference numbers, and explanations thereof are omitted below.

As in Embodiment 1, the image similarity calculation unit 114 includes the feature correction unit 121, the image object similarity calculation unit 116, the similarity determination unit 123, and the average similarity calculation unit 122. The present Embodiment differs only in the function of the feature correction unit 121. Given that the image object similarity calculation unit 116, the similarity determination unit 123, and the average similarity calculation unit 122 are identical to those of Embodiment 1, explanations thereof are omitted.

The feature correction unit 121 reads the object features included in each of the images having an image ID specified by notification from the image object quantity comparative determination unit 115 from the object feature memory 104.

The feature correction unit 121 then corrects the object features of each object included in low-priority image In as read out from the object feature memory 104 and outputs the result. This correction is performed using correction function F3, where the object features of an object included in high-priority image Im and the object features of an object included in low-priority image In are taken as parameters.

Here, correction function F3 is a function adding the average of the difference between the object features of the objects included in low-priority image In and in high-priority image Im to the object features of the objects included in low-priority image In.

In other words, let the object feature vectors of the objects included in high-priority image Im be Pu1(Pu11, Pu12 . . . Pu1n), Pu2(Pu21, Pu22 . . . Pu2n) Puv(Puv1, Puv2 . . . Puvn), let the objet feature vectors of the objects included in low-priority image In be Pw1(Pw11, Pw12 . . . Pw1n), Pw2(Pw21, Pw22 . . . Pw2n) Pwv(Pwv1, Pwv2 . . . Pwvn), and let the post-correction feature vectors Pw1, Pw2 . . . Pwv be Pw1c(Pw11c, Pw12c . . . Pw1nc), Pw2c(Pw21c, Pw22c . . . Pw2nc) . . . Pwvc(Pwv1c, Pwv2c . . . Pwvnc). Correction function F3(P) is thus the relational expression given by Math. 6.

$$Pwxc ( x = 1 , 2 , … , v ) = ( \begin{matrix}Pwx 1 c \\ Pwx 2 c \\ ⋮ \\ Pwxnc\end{matrix} ) = F 3 ( Pux ( x = 1 , 2 , … , v ) ) = ( \begin{matrix}( {\sum }_{x = 1}^{v} Pux 1 / v - {\sum }_{x = 1}^{v} Pwx 1 / v ) \times Pwx 1 \\ ( {\sum }_{x = 1}^{v} Pux 2 / v - {\sum }_{x = 1}^{v} Pwx 2 / v ) \times Pwx 2 \\ ( {\sum }_{x = 1}^{v} Puxn / v - {\sum }_{x = 1}^{v} Pwxn / v ) \times Pwxn\end{matrix} ) ( x = 1 , 2 , … , v ) \qquad [ Math . 6 ]$$

The following describes an example in which the image object quantity comparative determination unit 115 notifies the feature correction unit 121 of the image IDs I012 as a high-priority image and I013 as a low-priority image.

As shown in FIG. 14, the feature correction unit 121 calculates average feature value vector G012 from the object features of objects P031, P032, and P033 included in image I012. Similarly, as shown in FIG. 15, the feature correction unit 121 calculates average feature value vector G013 from the object features of objects P028, P029, and P030 included in image I013.

In the present Embodiment, the feature correction unit 121 has no need to carry out the processing described in Embodiments 1 and 2 whereby zeroes are replaced when any of the feature components in average feature value vector G013 is zero. As such, the operations of the feature correction unit 121 are simplified.

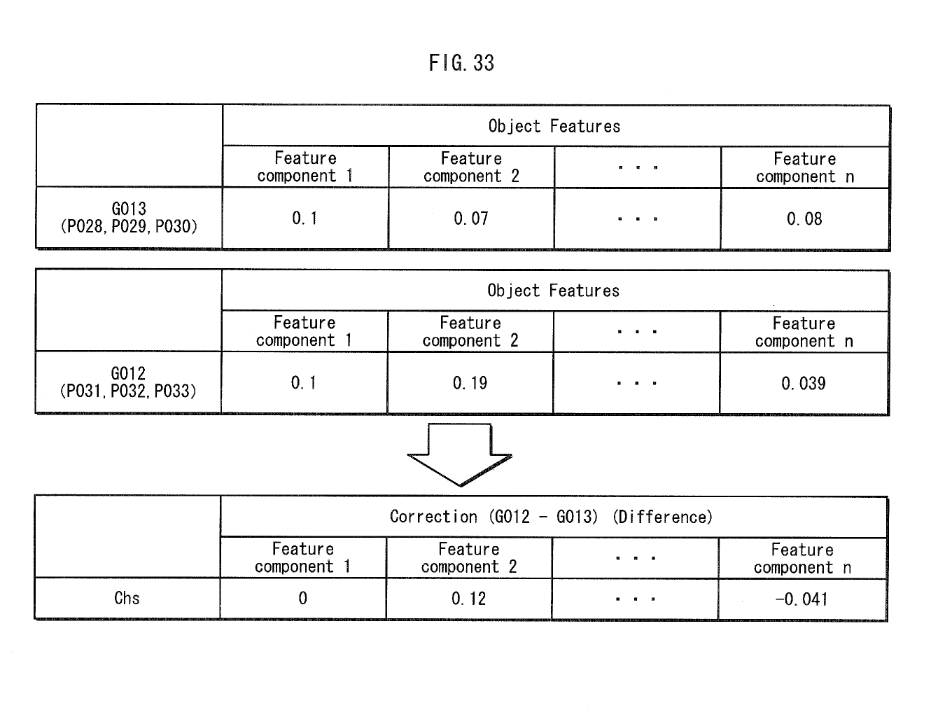

The feature correction unit 121 calculates the difference between the feature components of average feature value vector G012 and those of average feature value vector G013 (the result of subtracting the feature components of average feature value vector G013 from those of average feature value vector G012) to calculate correction vector Chs (see FIG. 33). The components of the resulting correction vector Chs and those of feature vectors P028, P029, and P030 are summed to obtain the coefficients of correction function F3. The feature correction unit 121 outputs feature vectors P028c, P029c, and P030c, obtained using correction function F3 with feature vectors P028, P029, P030 as input, to the image object similarity calculation unit 116.

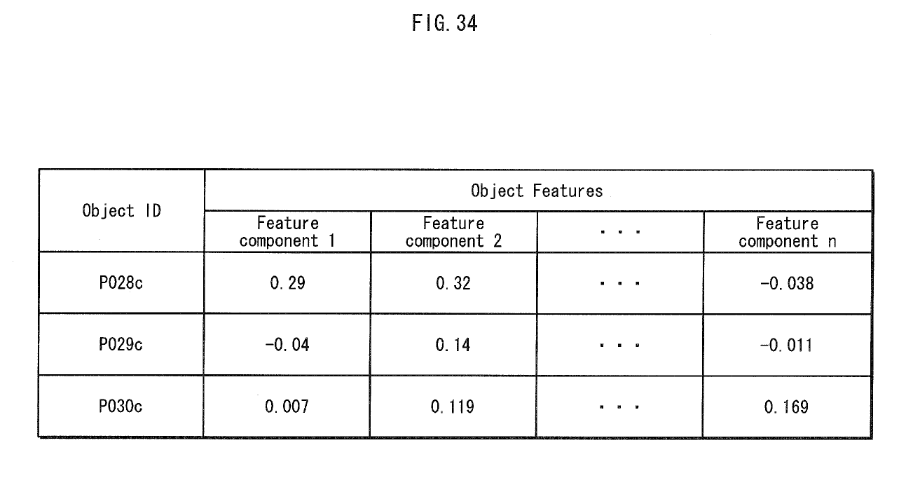

FIG. 34 lists the object features obtained by the feature correction unit 121 after corrections are applied to the object features using correction function F3, for the objects included in image I013.

2. Operations

The overall operations of the image management device pertaining to the present Embodiment are similar to those of Embodiment 1 (see FIG. 28), and are thus omitted. The present Embodiment differs from Embodiment 1 only in the image object similarity calculation process. The following describes the object similarity calculation process only.

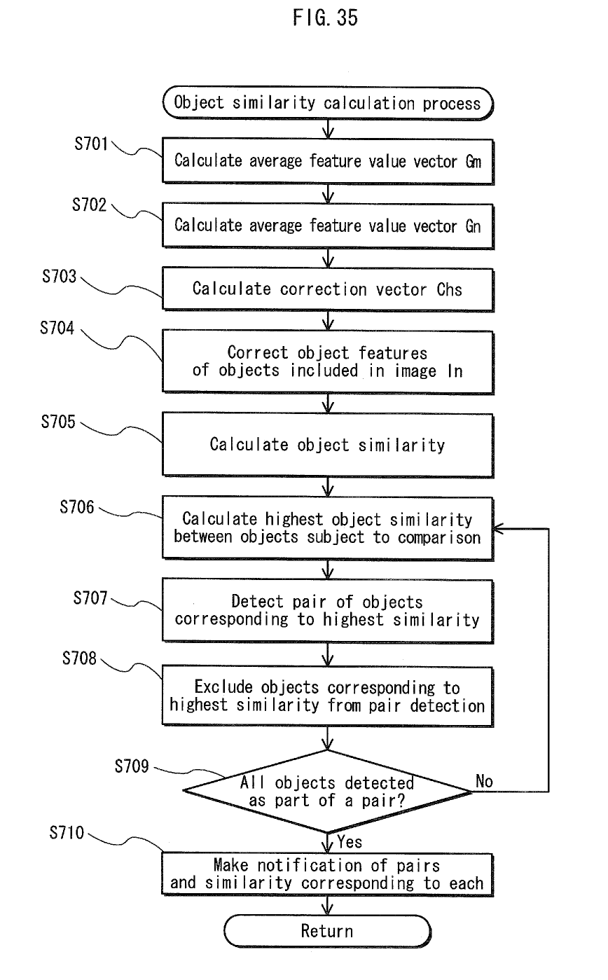

FIG. 35 is a flowchart of the object similarity calculation process.

First, average feature value vector Gm is calculated as the object feature vector of an object included in high-priority image Im (in this example, average feature value vector G012 is described for an object included in image I012) (step S701).

Next, average feature value vector Gn is calculated as the object feature vector of an object included in low-priority image In (in this example, average feature value vector G013 is described for an object included in image I013 (step S702).

Subsequently, correction vector Chs is computed by calculating the difference between each component of average feature value vector G012 for objects P31, P32, and P33 included in high-priority image I012, and average feature value vector G013 for objects P28, P29, and P30 included in low-priority image I013 (step S703).

Next, the feature correction unit 121 calculates feature vectors for objects P28c, P29c, and P30c by taking correction function F3 and using correction vector Chs with objects P28, P29, and P30 included in image I013 as input (step S704). Here, correction function F3 adds the components of correction vector Chs to the components of the respective object feature vectors of objects P28, P29, and P30.

Next, the similarity between the objects included in image I012 and the same objects as corrected using correction vector Ch is calculated (step S705).

The process of steps S706 through S710 is identical to that described in Embodiment 1 as steps S206 through S210 of the object similarity calculation process. The explanation thereof is thus omitted.

### Embodiment 4

The image management device pertaining to the present invention is configured to be substantially similar to FIG. 1, differing only in the functions of the object detection unit 103 and the image priority correction unit 117. Components identical to those of FIG. 1 use the same reference numbers, and explanations thereof are omitted below.

The object detection unit 103 calculates the size of each object as an object feature, then stores the size, in correspondence with the image ID of the image in which the object is included, in the object feature memory 104.

First, the image priority correction unit 117 obtains the size of the objects included in high-priority image Im and in low-priority image In from the object feature memory 104. The image priority correction unit 117 then calculates the average of size of the objects so obtained for image Im and image In. The image priority correction unit 117 corrects the image priority of low-priority image In using the similarity output by the average similarity calculation unit 122, which is configured as part of the image similarity calculation unit 114, and the image priority of high-priority image Im and of low-priority image In as stored in the image priority memory 323. The correction is based on the size of the objects as calculated by the object detection unit 103.

Here, the image priority correction unit 117 uses the relational expression given in Math. 7 to calculate a new image priority Scn′ for low-priority image In by correcting the image priority Scn of low-priority image In.

Scn′=(Scm−Scn)×Sg×(Ssavem/Ssaven)+Scn [Math. 7]

where Sg is the image similarity, Scm is the image priority of high-priority image Im, Scn is the image priority of low-priority image In, Ssaven is the average size of the objects included in low-priority image In, and Ssavem is the average size of the objects included in high-priority image Im.

The average sizes Ssaven and Ssavem are found by, for example, comparing each object to the surface area of a template provided for such use.

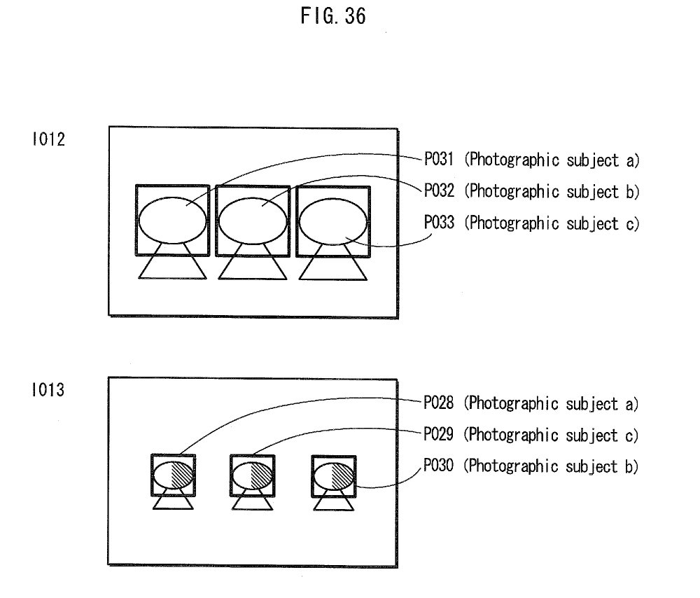

For example, as shown in FIG. 36, the image priority of high-priority image I012 is 101, the image priority of low-priority image I013 is 5, the image similarity between high-priority image I012 and low-priority image I013 is 0.78, the average size of objects P031, P032, and P033 included in high-priority image I012 is 0.2, and the average size of objects P028, P029, and P030 included in low-priority image I013 is also 0.2. Thus, the image priority correction unit 117 corrects the image priority of low-priority image In to (101−5)×0.78×(0.1/0.2)+5=42.44.

The image priority correction unit 117 also stores image priority Scn′ as calculated in the image priority memory 323, and notifies the image selection unit 111 and the image re-ranking unit 118 to the effect that correction is complete.

(Variations)

(1) In Embodiments 1 through 3, described above, the image object similarity calculation unit 116 is described as calculating the product of two object features. However, no limitation is intended in this regard. The image object similarity calculation unit 116 may also, for example, calculate the Euclidian distance between two object features.
(2) In Embodiments 1 through 3, described above, the image management device is given as an example. However, the present invention is not limited to devices having image management as a primary purpose. For example, any of a file server or similar storage device storing still or moving images, a playback device for still or moving images, a digital camera, mobile phone equipped with a camera, movie camera, or other image capture device, and a personal computer may all be employed.
(3) In Embodiments 1 through 3, above, the image acquisition unit 201 includes a USB input terminal and obtains a group of images from the image capture device 101 through a cable such as a USB cable. However, image acquisition need not necessarily be performed through the USB input terminal, provided that images are somehow obtained. For example, a group of images may be input through radio communications, or may be input using a recording medium such as a memory card.
(4) In Embodiments 1 through 3, described above, the image capture device 101 inputs the group of images to the image management device. However, no limitation is intended in this regard. Any device may be used, provided that a plurality of images are input to the image management device. For example, a file server storing images may input a plurality of images through a network. Alternatively, images need not necessarily be acquired from an outside source. The image management device itself may include a (non-diagramed) image storage device, such as a hard disk, and acquire images therefrom.
(5) In Embodiments 1 through 3, described above, the image acquisition unit 102 is described as generating image IDs assigned to the images for identification purposes. However, no limitation is intended in this regard. For example, the file name of a file made up of image data may be used to identify the corresponding image. Alternatively, the image data of each image may be stored in memory 131, and the initial address of the image data may be used to identify the corresponding image.
(6) In Embodiments 1 through 3, described above, the object detection unit 103 is described as using a template indicating a human face to perform template matching. However, no limitation is intended in this regard. For example, templates indicating animals, vehicles, buildings, and so on may also be used to perform template matching. Alternatively, the object detection unit 103 may detect objects using a method other than template matching.
(7) In Embodiments 1 through 3, described above, the object sorting unit 105 is described as generating a plurality of clusters. However, no limitation is intended in this regard. For example, a plurality of clusters may be determined in advance.
(8) In Embodiments 1 through 3, described above, the image priority is a value calculated by summing the object priority of each object included in a given image. However, no limitation is intended in this regard. For example, the image priority may be the average object similarity of the objects included in a given image. Alternatively, the image priority may be the highest object priority among the object priorities of the objects included in a given image. Furthermore, the image priority may be a value obtained by weighting the sum or average of the object priorities of the objects included in a given image according to the proportional surface area occupied by the object within the given image.
(9) In Embodiments 1 through 3, above, the image priority is calculated from the objet priorities alone. However, no limitation is intended in this regard. For example, the background, the environmental conditions, and so on, relevant to image capture may be reflected in the object priority of the image.
(10) In Embodiments 1 through 3, described above, the group of images is output to the display device 120 as arranged in descending order of image priority. However, no limitation is intended in this regard. The group of images may be displayed in order of input, with meta-data indicating the image priority attached to each image, or may be the images may be displayed alongside the image priority or rank.
(11) In Embodiments 1 through 3, described above, the image output unit 119 includes an HDMI output terminal and the images are output from the image management device 100 to the display device 120 through an HDMI cable. However, no limitation is intended in this regard. The image output unit 119 may output images to the display device 120 through a DVI cable or the like.

Also, in Embodiments 1 and 2, the image management device 100 is described as outputting images to the display device 120. However, no limitation is intended in this regard. The image management device 100 may also, for example, output high-priority images to a (non-diagrammed) printer for printing. Alternatively, the image management device 100 may be connected a (non-diagramed) external memory device, such as a hard disk, and output the images thereto, along with meta-data indicating the image priority for each image.

(12) In Embodiments 1 through 3, the image management device 100 is described as storing data in memory 131. However, no limitation is intended in this regard. The data may also be stored on a hard disk or other data storage medium.
(13) In Embodiments 1 through 3, the object features are described as being extracted using a Gabor filter. However, no limitation is intended in this regard.
(14) In Embodiments 1 through 3, the image priority is described as being calculated using the object priority of the objects included in the image. However, no limitation is intended in this regard.
(15) In Embodiments 1 and 3, described above, correction functions F1 and F3 are respectively described as calculated according to average feature value vectors Gm and Gn. However, no limitation is intended in this regard. For example, when noise due to capture conditions and the like influences the absolute value of object features, correction functions F1 and F3 may instead be calculated according to a squared average of the features, where the squared average of each object feature is taken is a component.
(16) In Embodiments 1 through 3, described above, the image management device is described as ranking a plurality of still images. However, no limitation is intended in this regard. A plurality of video images may also be ranked. In such a case, a predetermined still image is selected from the plurality of still images making up a given video image, and ranking is performed as described above in Embodiments 1 through 3 on the selected still image.
(17) In Embodiments 1 through 3, described above, information identifying high-priority image Im as such is affixed to the image ID of the image so selected by the high-priority image selection unit 112, information identifying low-priority image In as such is affixed to the image ID of the image so selected by the low-priority image selection unit 113, and the image object quantity comparative determination unit 115 identifies high-priority image Im and low-priority image In using the information so affixed to the respective image IDs. However, no limitation is intended in this regard. For example, the image object quantity comparative determination unit 115 may store the image priority corresponding to a rank set by the user, then obtain the image priority of a specific image from the image priority memory 323 according to the image ID in a notification, compare the image priority so obtained to the predetermined image priority as stored, and thereby identify the image as a high-priority image Im or a low-priority image In.
(18) In Embodiments 1 through 3, described above, the image management device 100 is described as including a (non-diagramed) priority settings unit through which a predetermined rank may be set as desired. However, the user may also use the priority settings unit to set a rank (minimum rank) corresponding to the lowest-ranked image among the plurality of images selected by the low-priority image selection unit 113. According to this variation, the user may review the image priority of images ranked near the lowest rank (images evaluated as low-priority images) by lowering the predetermined rank. Alternatively, the user may wish to restrict the set of images under image priority review to those of a certain rank so as to reduce the processing load. To this end, the user may raise the predetermined rank.
(19) In Embodiments 1 through 3, the object sorting unit 105 is described as automatically generating clusters using the k-means method in accordance with the object feature vectors of each object as stored in the object feature memory 104. However, no limitation is intended in this regard. The clusters may also be generated using Ward's method or the like.
(20) In Embodiment 4, described above, the image priority of low-priority image In is described as being corrected using the relational expression of Math. 7. However, no limitation is intended in this regard. For example, the image priority correction unit 117 may use the relational expression given in Math. 8 to calculate the new image priority Scn′ for low-priority image In, by correcting the image priority Scn of low-priority image In.

Scn′=(Scm−Scn)×Sg×F(Ssavem/Ssaven)+Scn [Math. 8]

where Sg is the image similarity, Scm is the image priority of high-priority image Im, Scn is the image priority of low-priority image In, Ssaven is the average size of the objects included in low-priority image In, Ssavem is the average size of the objects included in high-priority image Im, and F(X) is a monotonically increasing function.

The monotonically increasing function F(X) is, for example, derived from a logarithmic function or exponential function.

### (Notes)

(1) The present invention may be realized as a control program made up of program code for execution by a processor or by circuits connected to a processor, in an image management device performing image priority evaluation and the like as described in Embodiment 1. Such a program may then be recorded on a recording medium or transferred through various communication waves for distribution. The recording medium in question may be an IC card, a hard disk, and optical disc, a floppy disc, ROM, and so on. The control program so transferred and distributed is provided in a form amenable to storage in memory and reading therefrom by a processor. The processor is then able to realize the functions indicated in the Embodiments by executing the control program. A portion of the control program may be transmitted through some type of network to another device (processor) capable of executing programs. As such, the other device may execute a portion of the control program.
(2) The components of the image management device may be realized, in whole or in part, as one or more integrated circuits (IC, LSI, etc.), and may further be integrated (as a single chip) along with other components.

The integrated circuit method is not limited to LSI but may also be IC, system LSI, super LSI, or ultra LSI, according to the degree of integration. Also, the integrated circuit method is not limited to LSI, but may also employ a private circuit or a general-purpose processor. After LSI manufacture, a FPGA (Field Programmable Gate Array) or a reconfigurable processor may be used. Further still, advances and discoveries in semiconductor technology may lead to a new technology replacing LSI. Functional blocks may, of course, be integrated using such future technology. The application of biotechnology and the like is also possible.

### INDUSTRIAL APPLICABILITY

The terminal device or control method therefor pertaining to the present invention is applicable to any device, digital camera, mobile phone with camera, movie camera or similar image capture device, personal computer, and the like storing still images or video.

### REFERENCE SIGNS LIST

100 Image management device
101 Image capture device
102 Image acquisition unit
103 Object detection unit
104 Object feature memory
105 Object sorting unit
106 Object priority calculation unit
107 Image priority calculation unit
108 Image ranking unit
109 Image object quantity extraction unit
110 Image object quantity memory
111 Image selection unit
112 High-priority image selection unit
113 Low-priority image selection unit
114 Image similarity calculation unit
115 Image object quantity comparative determination unit
116 Image object similarity calculation unit
117 Image priority correction unit
118 Image re-ranking unit
119 Image output unit
120 Display device
121, 221 Feature correction unit
122 Average similarity calculation unit
123, 222 Similarity determination unit
215 Object selection unit
223 Maximum similarity calculation unit
323 Image priority memory

1. An image management device, comprising:
an image priority calculation unit calculating an image priority for each of a plurality of images according to object features of each of a plurality of objects included in the images;
an image selection unit selecting, according to the image priority calculated for the images, a first image and a second image such that the image priority of the second image is lower than the image priority of the first image;
a feature correction unit correcting the object features of the objects included in the second image using a correction function that takes the object features of the objects included in the first image and the object features of the objects included in the second image as parameters;
an image similarity calculation unit calculating an image similarity representing a degree of similarity between the first image and the second image, the image similarity being calculated using the object features of the objects included in the first image and the object features of the objects included in the second image as corrected by the feature correction unit; and
an image priority correction unit correcting the image priority of the second image according to the image priority of the first image and the image similarity calculated by the image similarity calculation unit.

2. The image management device of claim 1, wherein
the image priority of the first image is higher than a predetermined priority, and the image priority of the second image is lower than the predetermined priority.

3. The image management device of claim 1, further comprising
an object quantity comparative determination unit comparing quantities of objects included in the first image and in the second image, wherein
the feature correction unit corrects the object features of the objects included in the second image when the object quantity comparative determination unit determines that the quantities of objects included in the first image and in the second image are equal.

4. The image management device of claim 3, wherein
when applied, the correction function corrects the object features of the objects included in the second image using a correction coefficient calculated from a first average value obtained for the object features of the objects included in the first image and from a second average value obtained for the object features of the objects included in the second image.

5. The image management device of claim 4, wherein
the correction coefficient is the ratio of the first average value to the second average value, and
the correction function multiplies the object features of the objects included in the second image by the correction coefficient.

6. The image management device of claim 4, wherein
the correction coefficient is the difference between the first average value and the second average value, and
the correction function adds the correction coefficient to the object features of the objects included in the second image.

7. The image management device of claim 5, wherein
the image similarity calculation unit further includes:
an image object similarity calculation unit calculating a respective similarity between each of the objects included in the first image and each of the objects included in the second image and establishing one-to-one correspondence between the objects included in the first image and the objects included in the second image according to the respective similarity so calculated; and
an average similarity calculation unit calculating an average similarity value from the similarities between objects for which the image object similarity calculation unit establishes one-to-one correspondence and outputting the result as the image similarity.

8. The image management device of claim 7, wherein
the image object similarity calculation unit establishes correspondence between a pair of objects corresponding to a highest similarity value as calculated, excludes the two objects, and then establishes correspondence between another pair of objects corresponding to a next highest similarity value.

9. The image management device of claim 1, wherein
the image priority correction unit further corrects the image priority of the second image according to the average size of the objects included in the first image and the average size of the objects included in the second image.

10. The image management device of claim 9, wherein
the image priority correction unit corrects the image priority of the second image using a relational expression as given below:
Scn′=(Scm−Scn)×Sg×(Ssavem/Ssaven)+Scn
where Sg is the image similarity, Scm is the image priority of the first image, Scn is the image priority of the second image, Ssaven is the average size of the objects included in the second image, and Ssavem is the average size of the objects included in the first image.

11. An image management device, comprising:
an image priority calculation unit calculating an image priority for a plurality of images according to object features of objects included in the images;
an image selection unit selecting, according to the image priority calculated for the images, a first image and a second image such that the image priority of the second image is lower than the image priority of the first image;
a feature correction unit correcting the object features of the objects included in the second image using a correction function that multiplies each of the object features of the objects included in the second image by the ratio of the object features of a selected object among the objects included in the first image to the object features of the objects included in the second image, and outputting the results;
an image similarity calculation unit calculating an image similarity representing a degree of similarity between the first image and the second image, the image similarity being calculated using the object features of the objects included in the first image and the object features of the objects included in the second image as output from the feature correction unit; and
an image priority correction unit correcting the image priority of the second image according the image similarity calculated by the image similarity calculation unit.

12. An image management method for execution by a computer, comprising:
an image priority calculation step of calculating an image priority for each of a plurality of images according to object features of each of a plurality of objects included in the images;
an image selection step of selecting, according to the image priority calculated for the images, a first image and a second image such that the image priority of the second image is lower than the image priority of the first image;
a feature correction step of correcting the object features of the objects included in the second image using a correction function that takes the object features of the objects included in the first image and the object features of the objects included in the second image as parameters;
an image similarity calculation step of calculating an image similarity representing a degree of similarity between the first image and the second image, the image similarity being calculated using the object features of the objects included in the first image and the object features of the objects included in the second image as corrected in the feature correction step; and
an image priority correction step of correcting the image priority of the second image according to the image priority of the first image and the image similarity calculated in the image similarity calculation step.

13. An image management program for execution by a computer managing a plurality of images, the image management program comprising:
an image priority calculation step of calculating an image priority for each of a plurality of images according to object features of each of a plurality of objects included in the images;
an image selection step of selecting, according to the image priority calculated for the images, a first image and a second image such that the image priority of the second image is lower than the image priority of the first image;
a feature correction step of correcting the object features of the objects included in the second image using a correction function that takes the object features of the objects included in the first image and the object features of the objects included in the second image as parameters;
an image similarity calculation step of calculating an image similarity representing a degree of similarity between the first image and the second image, the image similarity being calculated using the object features of the objects included in the first image and the object features of the objects included in the second image as corrected in the feature correction step; and
an image priority correction step of correcting the image priority of the second image according to the image priority of the first image and the image similarity calculated in the image similarity calculation step.

14. A recording medium on which is recorded an image management program for execution by a computer managing a plurality of images, the image management program comprising:
an image priority calculation step of calculating an image priority for each of a plurality of images according to object features of each of a plurality of objects included in the images;
an image selection step of selecting, according to the image priority calculated for the images, a first image and a second image such that the image priority of the second image is lower than the image priority of the first image;
a feature correction step of correcting the object features of the objects included in the second image using a correction function that takes the object features of the objects included in the first image and the object features of the objects included in the second image as parameters;
an image similarity calculation step of calculating an image similarity representing a degree of similarity between the first image and the second image, the image similarity being calculated using the object features of the objects included in the first image and the object features of the objects included in the second image as corrected in the feature correction step; and
an image priority correction step of correcting the image priority of the second image according to the image priority of the first image and the image similarity calculated in the image similarity calculation step.

15. An integrated circuit, comprising: an image priority calculation unit calculating an image priority for each of a plurality of images according to object features of each of a plurality of objects included in the images;
an image selection unit selecting, according to the image priority calculated for the images, a first image and a second image such that the image priority of the second image is lower than the image priority of the first image;
a feature correction unit correcting the object features of the objects included in the second image using a correction function that takes the object features of the objects included in the first image and the object features of the objects included in the second image as parameters;
an image similarity calculation unit calculating an image similarity representing a degree of similarity between the first image and the second image, the image similarity being calculated using the object features of the objects included in the first image and the object features of the objects included in the second image as corrected by the feature correction unit; and
an image priority correction unit correcting the image priority of the second image according to the image priority of the first image and the image similarity calculated by the image similarity calculation unit.
